(19) United States
(12) Patent Application Publication
(10) Pub. No.: US 2005/0227692 A1
(43) Pub. Date: Oct. 13, 2005

(54) Utilized-network selection method, communication system and mobile terminal

(76) Inventors: Shinichi Kawashima, Kawasaki (JP); Norio Murakami, Kawasaki (JP)

Correspondence Address: KATTEN MUCHIN ROSENMAN LLP, 575 MADISON AVENUE, NEW YORK, NY, 10022-2585, US

(21) Appl. No.: 10/939,263

(22) Filed: Sep. 10, 2004

(30) Foreign Application Priority Data
Mar. 25, 2004 (JP) JP2004-088455

(51) Int. Cl. H04Q 7/20

(52) U.S. Cl. 455/435.2; 455/552.1

(57) ABSTRACT

A mobile information terminal communicates with a terminal of another party by utilizing a prescribed network from among a plurality of networks. During communication with the other party by utilizing a first network, another network or deterioration of reception conditions is detected. When another network or deterioration of reception conditions is detected, a server system automatically selects a network for continuing communication (i.e., an ASP makes the selection automatically) or presents recommended networks on a display unit of the mobile information terminal so that the network for continuing communication may be selected on the side of the mobile information terminal and reported to the server system (i.e., the user makes the selection). Communication is continued via the selected network under the control of the server system.

### BACKGROUND OF THE INVENTION

This invention relates to a utilized-network selection method, a communication system and a mobile terminal. More particularly, the invention relates to a utilized-network selection method for a mobile terminal whereby the mobile terminal may communicate with the terminal of another party by utilizing a prescribed network from among multiple networks, to the related communication system and to the mobile terminal.

More specifically, the present invention relates to a utilized-network selection method, communication system and mobile terminal through which it is possible for a network to be selected and decided based upon the judgment of the user of a diversity network service in accordance with nature of communication by the user, the financial circumstances of the user and the conditions of the mobile environment, or for the network to be selected and decided automatically based upon the judgment of a server on the network side.

When a mobile terminal has moved into an environment in which it is capable of utilizing networks of two or more types, the mobile terminal usually accesses any one of the networks, initiates communication and continues communicating. In this case the network to which the mobile terminal becomes connected is that of a communications carrier with which the user has entered into an agreement previously; the user cannot access the network of a communications carrier with which there is no such agreement.

A terminal available in the art is a dual-mode terminal (e.g., DoPa, etc.) whereby a single mobile terminal may perform high-speed, high-quality packet data transmission in second and third generations of mobile communications. For example, the dual-mode terminal is adapted so as to be capable of communicating according to a GSM (Global System for Mobile communications) scheme, which is a second-generation scheme, and a CDMA scheme, which is a third-generation scheme. When the state of communication deteriorates, the dual-mode terminal continues communicating upon switching over to whichever of the GSM and CDMA networks offers the better reception, thereby assuring good communication quality. However, such service is a special service for a case where the communications carrier of the GSM network and the communications carrier of the CDMA network are the same. This service cannot be implement if the two communications carriers are different.

Further, software radio is available as a technique whereby a single terminal is shared by a wireless LAN and PHS. With software radio, a single terminal is capable of wireless-LAN communication and PHS communication but a software modification is necessary in order to achieve this. This service also is a special service for a case where the communications carrier of the wireless LAN and the communications carrier of PHS are the same. This service cannot be implemented if the two communications carriers are different.

Further, there is a technique whereby a single network access means is selected from a plurality of network access means in accordance with the position of the communication terminal (e.g., see the specification of JP2002-374259A). Specifically, access means capable of being used by the terminal at a present position is downloaded to the terminal from a server that possesses a number of network access means, and the terminal accesses the network using the network access means downloaded by the terminal. However, the mobile terminal requires a special design. Moreover, this technique cannot be utilized with existing mobile terminals.

Thus, the following challenges are encountered in existing mobile communications:

1) Usually when a mobile terminal originates or receives a call, the terminal is merely connected to the communication network via a base station (referred to generally as “Node-B/RNC) located in the service area of a specified communications carrier. Even if the radio-wave propagation conditions are somewhat poor at this time, the only method available is to communicate upon issuing a setup request (a request to set up a connection for communication). In other words, the state of the art is such that even if the radio-wave propagation conditions are better on a network other than that of the specified communications carrier, this other network cannot be utilized.

2) The radio network cannot be selected based upon the judgment of the user. For example, though it may be better to use a high-speed communication network to transmit a large quantity of data, the user may not have the finances. At such times the user may wish to communicate inexpensively using a low-speed network. However, the state of the art is such that an arrangement whereby the user can select the network has not yet been realized. In other words, it would be desirable if the user could select the network.

3) At the present time, the mobility of a user to a network different from a network of the same carrier cannot be assured (i.e., network changeover is not possible). Consequently, the communication network utilized whenever the user moves cannot be changed over to the optimum network. Hence, the environment is not one in which networks can be utilized seamlessly. This means that there is need for an arrangement in which a network offering good communication conditions can be selected for communication automatically. In other words, automatic changeover of the network by the server is desirable.

4) The foundation of seamless roaming and seamless handover is ALL-IP NW (network)/Mobile-IP NW (network), and implementing mobility (network changeover) based upon IP (Internet Protocol) addresses has been considered. However, no consideration has been given to an implementation method in which a “telephone number”, which is the identifier used in communication connections at the present time, is exploited as is.

### SUMMARY OF THE INVENTION

Accordingly, an object of the present invention is to make possible the selection of a network other than that of a specified communications carrier (i.e., network diversity), thereby enabling the utilization of any network exhibiting good radio-wave propagation conditions.

Another object of the present invention is to so arrange it that a radio network can be selected based upon the judgment of the user in a case where it is possible to access a plurality of networks.

A further object of the present invention is to so arrange it that a network exhibiting good communication conditions can be selected automatically in a case where it is possible to access a plurality of networks.

Another object of the present invention is to make possible network diversity in which a “telephone number”, which is the identifier used in communication connections at the present time, is exploited as is.

According to the present invention, the foregoing objects are attained by providing a utilized-network selection method for a mobile terminal whereby the mobile terminal communicates with a terminal of another party by utilizing a prescribed network from among a plurality of networks.

A first utilized-network selection method according to the present invention comprises the steps of providing a server system connected to each of the networks for exercising control whereby the mobile terminal is allowed to communicate with the other party via the prescribed network; during communication with the other party by utilizing a first network, the mobile terminal detecting another network or detecting deterioration of reception conditions; the server system selecting networks for continuing communication and presenting these networks to the mobile terminal when the other network is detected or when deterioration of reception conditions is detected; selecting, on the side of the mobile terminal, a network for continuing communication and reporting this to the server system; and continuing communication via the selected network under the control of the server system.

A second utilized-network selection method according to the present invention comprises the steps of providing a server system connected to each of the networks for exercising control whereby the mobile terminal is allowed to communicate with the other party via the prescribed network; during communication with the other party by utilizing a first network, the mobile terminal detecting another network or detecting deterioration of reception conditions; the server system automatically selecting a network for continuing communication when the other network is detected or when deterioration of reception conditions is detected; and continuing communication via the selected network under the control of the server system.

Further, the foregoing objects are attained by providing a communication system having a mobile terminal for communicating with a terminal of another party by utilizing a prescribed network from among a plurality of networks, and a server system connected to each of the networks for exercising control whereby the mobile terminal is allowed to communicate with the other party via the prescribed network. The mobile terminal in this communication system includes: means for detecting another network or deterioration of reception conditions during communication with the other party utilizing a first network; means for transmitting a service-start request to the server system when the other network is detected or when deterioration of reception conditions is detected; display means for displaying networks presented by the server system; and means for selecting a network presented by the server system; wherein the server system responds to the service-start request by obtaining networks for continuing communication and presenting these network to the mobile terminal; the network for continuing communication is finally selected and reported to the server system on the side of the mobile terminal; and communication is continued via the selected network under the control of the server system.

Further, the foregoing objects are attained by providing a mobile terminal in a communication system having the mobile terminal for communicating with a terminal of another party by utilizing a prescribed network from among a plurality of networks, and a server system connected to each of the networks for exercising control whereby the mobile terminal is allowed to communicate with the other party via the prescribed network.

A first mobile terminal according to the present invention includes: means for detecting another network or deterioration of reception conditions during communication with the other party utilizing a first network; means for transmitting a service-start request to the server system when another network is detected or when deterioration of reception conditions is detected; display means for displaying networks presented by the server system in response to the service-start request; and means for selecting a network presented by the server system; and means for notifying the server system of the selected network; wherein the server system continues communication via the network of which it has been notified by the mobile terminal.

A second mobile terminal according to the present invention includes: means for detecting another network or deterioration of reception conditions during communication with the other party utilizing a first network; and means for transmitting a service-start request to the server system when another network is detected or when deterioration of reception conditions is detected; wherein the server system selects a network for continuing communication in response to the service-start request and continues communication via this network.

The following advantages are obtained in accordance with the utilized-network selection method, communication system and mobile terminal according to the present invention:

1) Another communications carrier within the same network can be selected in a mobile communications (wireless communications) environment at the convenience of the user. As a result, an improvement at the time of voice/data communication and mobility are assured and it is possible to provide the user with greater convenience.

2) The present invention makes possible the connection to a network that reflects the volition of the user. By thus deciding the network of the mobile communications carrier utilized, the user per se is provided with a sense of the reasonableness of the network decided.

3) In a case where an automatic setting has been used, the optimum network environment can be used unconsciously to the user.

4) It is possible to also communicate with a non-contract network carrier (NWOP), using a temporarily utilized address, via the intermediary of an ASP, and continuance/mobility of communication can be maintained.

5) It is also possible to access an NW (network) provided by a different NWOP, and seamless handover (mobility) can be achieved.

Other features and advantages of the present invention will be apparent from the following description taken in conjunction with the accompanying drawings.

### BRIEF DESCRIPTION OF THE DRAWINGS

FIG. 1 is a diagram useful in describing the optimum form of the present invention;

FIG. 2 is a diagram illustrating the configuration of a communication system for implementing a service (a network diversity service) that selects an optimum network;

FIG. 3 is a conceptual view of a service area;

FIG. 4 illustrates an example of an initial screen for service selection on a mobile information terminal;

FIG. 5 illustrates examples of display screens showing a procedure for initial service registration;

FIG. 6 illustrates a sequence in initial service registration;

FIG. 7 is a diagram (part 1) useful in describing a procedure for starting implementation of service;

FIG. 8 is a diagram (part 2) useful in describing a procedure for starting implementation of service;

FIG. 9 illustrates examples of screens showing a procedure for confirming service settings;

FIG. 10 illustrates a sequence in a case where a network is decided by a “user selection scheme” in implementation of a network diversity service;

FIG. 11 illustrates a sequence in a case where a network is decided by an “ASP automatic selection scheme” in implementation of a network diversity service;

FIG. 12 is a functional block diagram of service registration processing executed by an ASP;

FIG. 13 is a functional block diagram illustrating processing executed by the ASP for comparing and analyzing radio conditions;

FIG. 14 is a functional block diagram of processing for reporting results of comparison;

FIG. 15 is a functional block diagram illustrating (temporary) connection-request processing for issuing a connection request to a communications carrier with which the user has no contract;

FIG. 16 is a functional block diagram illustrating processing for connecting/responding to a non-contract communications carrier;

FIG. 17 is a first processing flowchart illustrating the basic process of network diversity at a mobile information terminal;

FIG. 18 is a second processing flowchart illustrating the basic process of network diversity at a mobile information terminal;

FIG. 19 is a processing flowchart illustrating the basic process of network diversity at an ASP;

FIG. 20 is a diagram useful in describing a message-flow procedure based upon an IP address utilized in a WLAN network;

FIG. 21 illustrates service flow in a case where a communications carrier (NWOP) is selected by a user selection scheme (a case where there is a contract with the communications carrier);

FIG. 22 illustrates service flow in a case where a communications carrier (NWOP) is selected by a user selection scheme (a case where there is no contract with another communications carrier);

FIG. 23 illustrates service flow in a case where a communications carrier (NWOP) is selected by an ASP automatic selection scheme (a case where there is a contract with another communications carrier);

FIG. 24 illustrates service flow in a case where a communications carrier (NWOP) is selected by an ASP automatic selection scheme (a case where there is no contract with another communications carrier);

FIG. 25 illustrates a settlement process in a case where a user has utilized a hot spot of a non-contract WLAN carrier;

FIG. 26 illustrates a settlement process in a case where a user has utilized a network of a non-contract CDMA carrier; and

FIG. 27 illustrates an IP address acquisition process in a case where WLAN radio waves have been detected during CDMA NW communication.

### DESCRIPTION OF THE PREFERRED EMBODIMENTS

Overview of the Present Invention

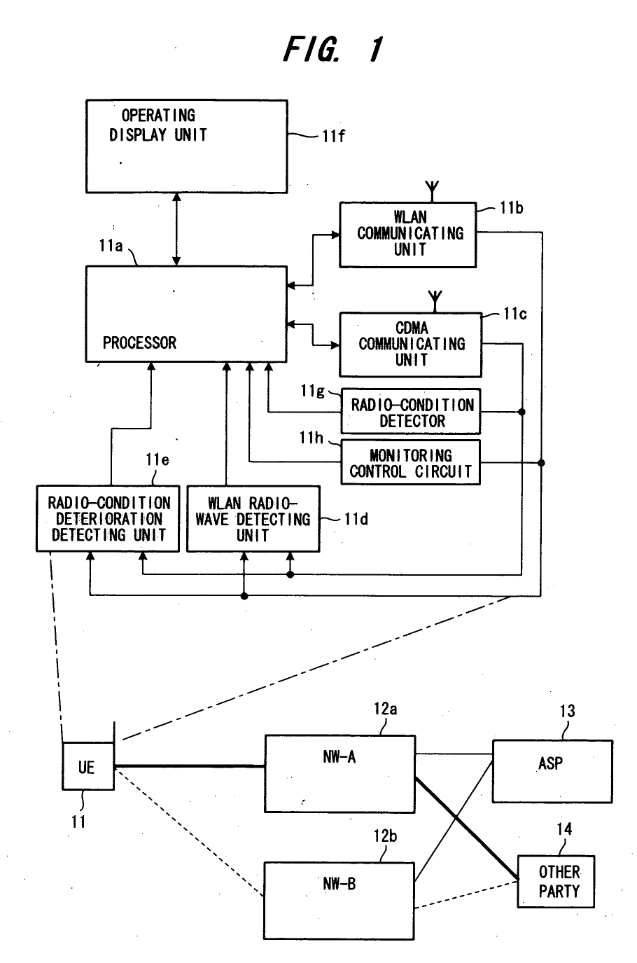

FIG. 1 is a diagram useful in describing the optimum form of the present invention. A mobile information terminal (mobile terminal) 11 has a communication unit that supports the wireless schemes in a plurality of networks (NW-A, NW-B) 12a, 12b and is capable of communicating with a terminal 14 of another party via these networks. The networks 12a, 12b are mobile radio wireless networks. For example, the network 12a is a CDMA network and the network 12b a WLAN (Wireless LAN) network. An ASP (Application Service Provider, which is a server system) 13 implements a network diversity service according to the present invention. The ASP 13 decides, in response to a service-start request from the mobile information terminal 11, which of the networks 12a, 12b the mobile information terminal 11 is to utilize to communicate with the other party's terminal 14 and presents this on the display unit of the mobile information terminal 11 (this is a user selection scheme). Alternatively, the ASP 13 selects a network automatically (this is an ASP automatic selection scheme). The mobile information terminal 11 is connected to the other party's terminal 14 via the network selected by the user or the network selected automatically by the ASP. When the radio conditions of the network currently being used in communication deteriorate, or when another network is detected, the mobile information terminal 11 sends a service-start request to the ASP 13. For example, the mobile information terminal 11 sends the service-start request to the ASP 13 when the radio conditions of the WLAN network deteriorate during WLAN communication or when WLAN radio waves are detected during CDMA communication.

The mobile information terminal 11 includes a processor 11a for executing control of mobile communication, a WLAN communicating unit 11b, a CDMA communicating unit 11c, operating display unit 11f, a WLAN radio-wave detecting unit lid, a radio-condition deterioration detecting unit 11e for detecting that that radio conditions have deteriorated, and detectors 11g, 11h for detecting radio conditions (RSSI: Receive Signal Strength Indicator) of the networks 12a, 12b.

When the mobile information terminal 11 detects WLAN radio waves from a hot spot owing to travel during communication with the other party's terminal 14 via the CDMA network 12a, as indicated by the bold lines in FIG. 1, the mobile information terminal 11 sends the service-start-request to the ASP 13. In response, the ASP 13 compares the radio conditions of the networks 12a, 12b, displays the optimum network on the mobile information terminal operating display unit 11f of the mobile information terminal 11 and adopts the network, which is selected by the user, as the network for continuing communication (this is the user selection scheme). Alternatively, the ASP 13 selects the optimum network automatically as the network for continuing communication (this is the ASP automatic selection scheme). For example, if the WLAN network 12b has been selected as the network for continuing communication, then the mobile information terminal 11 and the other party's terminal 14 subsequently communicate under the control of the ASP via the WLAN network 12b.

When the communication conditions of the WLAN network 12b deteriorate owing to travel during communication between the mobile information terminal 11 and the other party's terminal 14 via the WLAN network 12b, as indicated by the dashed lines in FIG. 1, the mobile information terminal 11 sends the service-start-request to the ASP 13. In response, the ASP 13 compares the radio conditions of the networks 12a, 12b, displays the optimum network on the mobile information terminal operating display unit 11f of the mobile information terminal 11 and adopts the network, which is selected by the user, as the network for continuing communication (this is the user selection scheme). Alternatively, the ASP 13 selects the optimum network automatically as the network for continuing communication (this is the ASP automatic selection scheme). For example, if the CDMA network 12a has been selected, then the mobile information terminal 11 and the other party's terminal 14 subsequently communicate under the control of the ASP via the CDMA network 12a.

The foregoing is for a case where the mobile information terminal has entered into a contracted agreement with the network carriers of both networks. However, there are instances where one of the networks in a non-contract network. For example, there are instances where if networks 12a, 12b are CDMA networks, communication via network 12a is contracted but not via network 12b. In order to allow handover from network 12a to network 12b in such case, the ASP 13 acquires temporary access permission and a provisional telephone number from the non-contract network 12b and notifies the mobile information terminal of the provisional telephone number. The mobile information terminal communicates with the other party's terminal via the network 12b using this provisional telephone number.

Though an overview of the invention has been described while limiting the number of networks to two, it should be noted that the invention is not limited to two networks.

First Embodiment

(A) Overall System Configuration

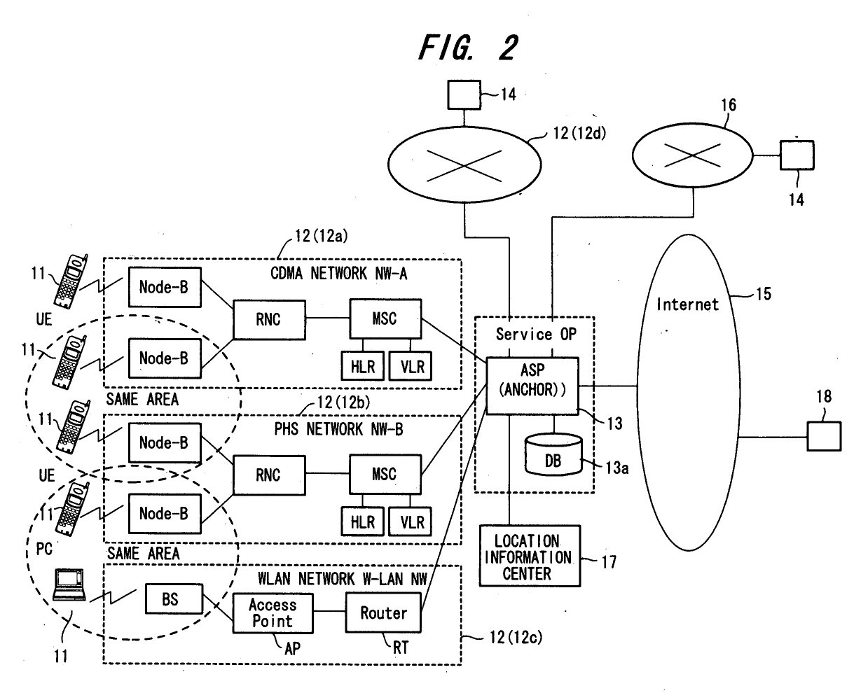

FIG. 2 is a diagram illustrating the configuration of a communication system for implementing a service (a network diversity service) that selects an optimum network. This communication system implements the network diversity service based upon the communication content and characteristics of the mobile information terminal and the radio conditions in a mobile communications environment. This communication system includes the mobile information terminal (UE) 11, a public mobile communications network (NW) 12, the ASP 13 serving as a service operator, an ordinary information terminal 14, the Internet 15, a private mobile communications network (an intracorporate network, etc.) 16, an location information center 17 and a communicating party 18.

The mobile information terminal (UE) 11 has voice communication and data communication functions and has a function that allows it to be connected as an Internet terminal (namely functions for WWW access, display, voice playback, e-mail send and receive for handling data such as text, still pictures, moving pictures, voice and music, etc.). The mobile information terminal 11 includes such mobile information terminals as a mobile telephone, notebook personal computer and PDA, etc., though the terminal is not limited to these. For example, the communication function and display function may be separated and implemented by separate devices. Further, the mobile information terminal 11 is capable of supporting all NWOPs (communications carriers) 12a to 12c such as IMT-2000 (W-CDMA) and W-LAN (wireless LAN). The mobile information terminal 11 will be referred to simply as a mobile terminal or terminal below.

The public mobile communications network (NW) 12 is a 3G-mobile cellular telephone network (CDMA network NW-A) 12a, a public wireless PHS network (PHS network NW-B) 12b and a public wireless LAN network (WLAN network W-LAN NW) 12c, etc., connected when the terminal communicates. When the mobile information terminal 11 communicates, these networks are connected and function to establish communication and perform management and control, etc. Further, each network is internally provided with a function for relaying data in a case where the mobile information terminal 11 sends and receives data to and from the Internet 15 or intracorporate network 16, etc. The CDMA network 12a and PHS network 12b have an MSC (Mobile Service Switching Center), a wireless network controller RNC, and a number of base stations Node-B connected to the RNC. Though only one RNC is illustrated in FIG. 2, a plurality of RNCs are actually connected to the MSC. Further, a home location register HLR and a visitor location register VLR are connected to the mobile service switching center MSC. The HLR stores the telephone number, location, base station and subscriber information, etc. of the mobile information terminal 11 under control, and the VLR stores the telephone number, location, network and subscriber information, etc. of the mobile information terminal that uses the network temporarily, the network being used by a non-contracting individual. The WLAN network 12c has a hot-spot base station BS, an access point AP and a router RT.

The Internet 15 is a communication network that sends and receives data by TCP/IP and has a function for sending and receiving information to and from various computer systems (servers, etc.) or other terminals when the mobile information terminal 11 or the ordinary information terminal 14 such as a personal computer is connected thereto. The ordinary information terminal 14 is one part of the Internet and is a terminal such as a personal computer capable of connection to the Internet. Connection is also possible via a public/private mobile communications network or LAN of a private enterprise.

The ASP (Application Service Provider, which is a server system) 13 serving as the service operator is equipped with a database (DB) 13a. The ASP 13 has all of the functions of an ordinary Internet server system and, in addition, has various functions for implementing the network diversity service based upon the present invention. The ASP 13 provides this service to the terminals 14, 11 via the network 12, Internet 15 and intracorporate network 16. The ASP 13 has the following means:

(a) The ASP 13 has an interface for sending and receiving various information to and from the user who utilizes this service (the network diversity service), and a function for receiving and recording service-user position information that is sent from the interface from time to time autonomously or that is sent from the server system in accordance with a request.

(b) The ASP 13 has a function for calculating and recording the location or travel displacement of the service user based upon location information obtained in accordance with function (a) above.

(c) The ASP 13 has a function whereby the network carrier is queried about location information of the network service area (e.g., a hot spot of a public wireless LAN carrier) and the information is recorded.

(d) The ASP 13 has a function for comparing the result obtained by the function of (b) above with the service area of the network carrier and deciding the utilizable network.

The location information center 17 is equipped with a function for generating and transferring information indicating the position of the mobile information terminal 11. This is a function of the terminal alone (e.g., a GPS function) or as a network function. The location information is information for specifying the position of the mobile information terminal 11 and indicates data such as latitude and longitude.

The communicating party 18, which is the destination with which the mobile information terminal 11 communicates, is a facility such as an information provider (a content provider, etc.), a communication device, an information terminal or a server system, etc. The communicating party 18 is connected to the ASP 13 via the public mobile communications network (NW) 12 or Internet 15, etc.

The communication system of FIG. 2 adds the ASP 13, which serves as a service operator, to the conventional system configuration, and implements control and exchange of information between the ASP 13 and the communications carrier (NWOP hereafter) 12. As a result, with the ASP 13 as the nucleus, it is possible to achieve a better mobile communications (radio communication) environment or to select another communications carrier in the same network based upon the intent of the user, thereby assuring an improvement at the time of voice/data communication as well as mobility and affording greater convenience for the user.

(B) Functions for Implementing Network Diversity Service

The communication system of the present invention has the functions set forth below for implementing a network diversity service. It should be noted that the term “user” refers to both a mobile information terminal and the person using the terminal.

a) When a mobile information terminal that has subscribed to the service originates a call, the user receives comparison information from the ASP 13 concerning the radio-wave propagation conditions of the networks and can select a network having better conditions in the same area.

b) More advantageous information is supplied to the user by the ASP 13 and the network can be changed over by a selection scheme on the side of the user. This is a function that allows changeover by the user.

c) A user request such as the network desired by the user is registered with the ASP 13 in advance. The radio-wave propagation conditions are discriminated each time depending upon the location of the user and the network is changed over automatically. This is a function whereby the ASP makes the selection automatically.

d) When power is introduced to the mobile information terminal (i.e., when the position thereof is registered) and when the terminal is situated at a boundary between radio areas (i.e., when the terminal is in a handover area), the mobile information terminal detects the radio conditions in this area and reports radio-environment information (Forward-Pilot CH of each radio scheme) to the ASP 13.

e) In order to ascertain the radio conditions of each radio scheme, the radio-wave propagation conditions are discriminated by the ASP based upon notification of the Forward-Pilot CH (e.g., RSSI) of the radio scheme on the side of each terminal or based upon the distance from the terminal position, which is obtained by GPS or the like, to each access point AP of hot spots.

f) The ASP 13 makes a comparison and analysis of the best NWOPs (communications carriers) for the user by referring to registered information as criteria for deciding upon selection by the user or automatic selection by the ASP, the information indicating whether communication time has priority, whether communication cost has priority, and the default setting (automatic selection by the communications carrier is set by preliminary registration).

g) The ASP 13 displays an ASP-specified selection menu on the display unit of the mobile information terminal and causes the selection menu to display radio schemes of communications carriers in the same area as that of the radio scheme of the existing communications carrier.

h) Collection of location information, subscriber registration, call connection and collection of billing information are performed utilizing the functions of the existing network as is. Only user registration management and billing information management relating to the network diversity service is performed by an external ASP operator in alliance with the NWOP (communications carrier).

i) The ASP 13 has the following functions as an anchor for controlling this service:
a function for acquiring information concerning radio environment conditions of a plurality of networks;
a function for comparing acquired radio environment conditions and deciding upon the priority network;
a function for maintaining the call connection and communication connection to the selected communication network (this is a handover function);
an intermediary function for settlement of accounts between utilized communication networks (this is a billing function);
a function having a transmission-line buffer mechanism that accommodates for disparities ascribable to changes in the communication environment;
a service registration and maintenance management function (a database function);
a function for managing correlation of address identifiers user by user at the time of service utilization;
a function for managing mobility of the service terminal and utilized service;
a function for assigning IP addresses to service terminals by DHCP (Dynamic Host Configuration Protocol) (this is an IP address assignment function); and
a procedure for temporary utilization of a communication network of a non-contract NWOP (communications carrier) at the time of service utilization, and a function for assigning a terminal a temporary address of a non-contract NWOP.

(C) Recognizing Radio-Wave Propagation Conditions of each Communications Carrier

a) When power is introduced, the mobile information terminal 11 such as IMT 2000 registers location information with each NWOP (communications carrier) (performs position registration), receives Forward-Pilot CH (RSSI) from each NWOP and recognizes the radio-wave propagation conditions of the area. Further, the mobile information terminal 11 attaches received radio-wave propagation information to the RNC as a periodic report. Radio-wave propagation information (Forward-Pilot CH RSSI of each radio scheme) reported from the mobile information terminal 11 is transmitted from the NWOP to the ASP 13 in a format (text, etc.) decided between the ASP 13 and the NWOP. On the basis of this information, the ASP 13 compares and judges the radio environment conditions of every NWOP (communications carrier) and selects a better NWOP.

b) A mechanism that allows the terminal itself to select a plurality of radio states is provided, a multi-chip is mounted and multi-interface changeover is made possible.

c) The radio-wave propagation conditions of the W-LAN are judged. Specifically, on the basis of location information of the mobile information terminal 11 of IMT 2000 (CDMA network), which is to undergo comparison, and location information of access point AP in the hot spot of the W-LAN, the distance to the access point is calculated, the ASP 13 performs a calculation based upon this distance and judges the radio-wave propagation conditions.

(D) Judging Utilized Network Based upon Mobile Communication Environment
a) Communication-Network Comparison and Analysis Parameter

Terminal reception level RSSI (dBm) is used as a parameter to undergo comparison and analysis in regard to quality of the communication network.

b) Decision Logic

Logic for deciding the network to be utilized includes b-1) to b-5) below.

b-1) Utilized-Network Decision Logic at ASP

Processing executed by the ASP for comparing and analyzing radio conditions performs a comparison between mobile communication NWOPs using RSSI and selects whichever has the higher value.

Between LANs, based upon the position of access point AP of a hot spot and location information (GPS, etc.) of the mobile information terminal 11, the RSSI value is obtained by simple calculation (utilization of a free-space propagation equation), a comparison is performed in a similar manner by the ASP 13 and the NWOP having the larger value is selected.

b-2) Decision Logic Based upon Attributes of Communicating Party and Mobility of Mobile Information Terminal

A communication network that is optimum in economic terms is decided by data transmission capability of the communication network on the originating/terminating sides. A mobile-communication NWOP such as CDMA is selected if the terminal is moving, and a NWOP of a WLAN is selected if the terminal is stationary. Table 1 below indicates communication networks decided by the attributes of the communicating party.

TABLE 1

COMMUNICATING PARTY

| | CDMA | WLAN |
|---|---|---|
| TERMINAL | (LOW-SPEED NW) | (HIGH-SPEED NW) |
| CDMA | CDMA | WLAN |
| WLAN | CDMA | WLAN |

b-3) Decision Logic Based upon Call Set-Up Connection Sequence

Communication-network connection sequence identifiers (Tel. No., IP address, etc.), which are based upon a difference in communication-network addresses on the call originating/terminating sides, are as set forth below. Conversion of identifiers indicated in Table 2 need to be changed whenever the originating side switches from CDMA to WLAN and from WLAN to CDMA.

TABLE 2

| | TERMINATING SIDE | |
|---|---|---|
| | TEL. NO. (NW | IP ADDRESS |
| ORIGINATING SIDE | SUCH AS CDMA) | (NW SUCH AS WLAN) |
| TEL. NO. (CDMA) | TEL. NO. | TEL. NO. → IP |
| | | ADDRESS |
| IP ADDRESS | IP ADDRESS → | IP ADDRESS |
| (WLAN) | TEL. NO. | |

(1) In case of outgoing call from CDMA communication network to WLAN communication network:

When CMDA call generates by Tel. No. +α, ASP assigns an IP address based upon DHCP and connects to W-LAN by an IP address.

(2) In case of outgoing call from WLAN communication network to CDMA communication network:

ASP assigns an IP address by DHCP, and connects to W-LAN by an IP address, then ASP searches telephone numbers based upon user ID and places a call by Tel. No.

Table 3 below is an example of an address management correspondence table of a mobile information terminal. The ASP has an address management correspondence table in order to perform call set-up processing in a different network invisibly, correlates terminal addresses, identifiers and telephone numbers that bridge different networks, obtains an identifier from the correspondence table and continues communication with the different network based upon the identifier.

TABLE 3

| | UE ID | UE ID | IP ADDRESS | RADIO |
|---|---|---|---|---|
| USER ID | (TEL. NO.) | (ESN) | (DHCP) | BEARER |
| 11 | 0x0-xxxx-xxxx | ABCDEFG | Aa.bb.cc.dd | 1 |

b-4) Decision Logic Based upon user Fee Invoice

With regard to a criterion based upon billing, identification is possible based upon assurance of communication band by data call at the start of the service and based upon a prediction of conversation time by the utilized service.

b-5) Decision Logic of Utilized Network Based upon user

The results of b-1) to b-4) are displayed on a screen provided by the service and the option is selected based upon the preferences of the user.

(E) Control of Mobility between Communications Carriers

a) Procedure for Maintaining Communication Connection

If a communication connection via a first network NW-A is established in a case where the communication connection is changed from the first network NW-A (e.g., a CDMA network) to a second network NW-B (e.g., a WLAN network), the NW-A communication connection is maintained until the communication conditions in the NW-A/NW-B radio zone can be recognized and communication connection via NW-B is established.

At this time the identifiers (addresses) of respective ones of the NW-A and NW-B are correlated and communication is continued using the identifier of the NW-B.

The communication connection, inclusive of the bearer, is changed to pass through the NW-B.

b) Concept of Service Area

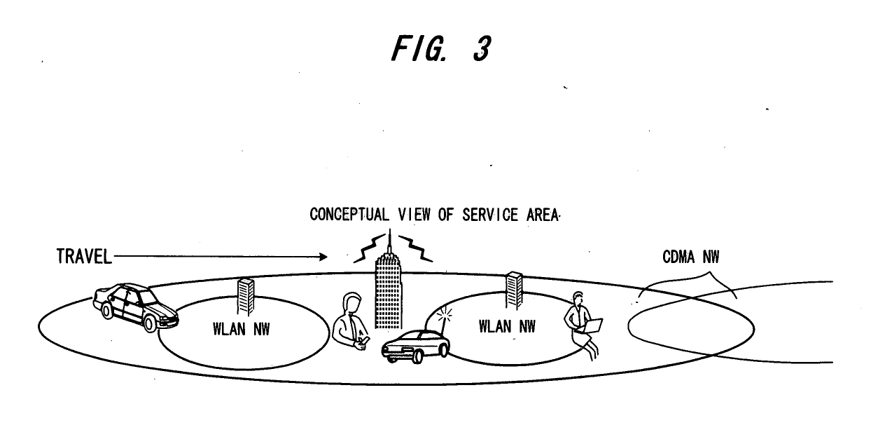

FIG. 3 is a conceptual view of a service area. With regard to the size of the service area, and in case of CDMA and WLAN, CDMA NW>>WLAN NW holds, and the WLAN NW is included in the CDMA NW. Owing to such an inclusion relation, it is possible to distinguish the regional communication network merely by discriminating the radio conditions of the WLAN. If the radio conditions of the WLAN are good, the terminal is located in the area of the WLAN NW (the CDMA radio waves are reaching the WLAN NW as well); if the radio conditions of the WLAN are no good, the terminal is located in the area of the CDMA NW.

c) Control of Mobility between Communications Carriers is as follows:
Between CDMA NW and WLAN NW: handover by ASP control
Between CDMA NW and CDMA NW: handover by RNC control
Between CDMA NW and GSM NW: handover by RNC control
Between CDMA NW and PHS/PDC NW: handover by ASP control
Between WLAN NW and WLAN NW: handover by ASP control
Between WLAN NW and PHS/PDC NW: handover by ASP control

Handover by RNC control is performed as heretofore. Handover by ASP control is a feature of the present invention.

(F) Overview of Network Diversity

1) As a network diversity function, the user receives information concerning the radio-wave propagation conditions when the terminal issues an outgoing call and can select a network exhibiting better conditions in the same area.

2) The ASP operator provides the user with more advantageous information and changes over the network by a selection scheme on the user side, thereby making it possible to shorten data transmission time or reduce the fee billed. This represents selection by the user.

3) It is possible to adopt a scheme in which the network desired by the user is registered in advance and the network is changed over automatically depending upon the location where the network is utilized by the user. A seamless environment can be achieved as a result. This represents automatic selection by the ASP.

4) All data such as communication radio conditions, subscriber data status (location registration, service settings) and billing status, etc., of each network relating to the network diversity service is managed on the ASP side, thereby making it unnecessary to maintain and manage data by the communications carrier.

5) An arrangement (function) in which the ASP is regarded as an “anchor” is provided, thereby making it possible to change over and select the radio scheme during terminal communication.

6) As an example of application, it is possible to adopt an arrangement in which a radio environment construed to be best by logic on the terminal side is automatically selected.

7) It is possible to select a radio environment intended by the user before a transition is made to the actual communicating state, and an arrangement in which control is performed during travel of the terminal and when the terminal is in the communicating state is made possible.

8) In case of voice and data, it is so arranged that a communications carrier in a radio zone can be distinguished and selected, and ultimately an arrangement in which a dedicated wireless network equivalent to a wired dedicated line can be implemented is made possible.

Second Embodiment

(A) Background

With an IMT-2000 system, information transmission capability in a radio zone is high and it is possible to send and receive multifarious media such as voice and images in a shorter period of time. In addition, specifications have been unified and an environment has been set up that makes it possible to achieve seamless communication service by allowing bridging of mobile communications carriers through international roaming.

Even with an IMT-2000 system, however, a mobile communications carrier to which the mobile information terminal of the user connects in the same manner as that of the conventional mobile communications schemes, and receives provision of a communication service is uniquely fixed and determined. The user cannot freely select the nature of his/her own communication and cannot freely select the connected mobile communications carrier in accordance with the circumstances of the user at the time. In other words, the user cannot select the network of the connected mobile communications carrier subjectively or intentionally.

The present invention makes it possible to select a mobile communications carrier in accordance with the nature of communication the user is attempting to perform (e.g., data transfer, image communication, voice, etc.) and the circumstances of the user at the time (the extent of the fees to be borne).

According to the present invention, the user compares communication environments (the conditions of radio zones) of a plurality of mobile communications carriers, with which subscriber and roaming contracts have been made, before the mobile information terminal of the user establishes communication with the communicating party via the network of the mobile communications carrier. As a result:

1) The network of the mobile communications carrier actually connected is selected according to the volition of the user based upon the nature of communication the user is about to perform and the intentions of other users.

2) By previously registering the conditions of the communication environment desired by the user at the time of communication, a connection to the network of a mobile communications carrier that matches or most nearly matches these conditions is uniquely selected, thereby making it possible to achieve, at all times, communication in a communications environment that is intended by the user.

By virtue of the foregoing, the user can select the network of a mobile communications carrier in accordance with the nature of communication or the circumstances of the user (e.g., a desire to finish communicating in a short time even though the communication fee is high, or a desire to alleviate the burden of the communication fee even though communication may take some time), or the user can always select the network of a mobile communications carrier in the best communications environment at the time of connection regardless of the fee burden. Thus, the volition of the user can be reflected in the decision regarding the network of the mobile communications carrier to be connected.

(B) Functions of Mobile Information Terminal for Implementing Network Diversity Service

A mobile information terminal for implementing a network diversity service has the following functions:

(1) The mobile information terminal 11 possesses a mechanism for communicating based upon a plurality of wireless schemes [e.g., W-CDMA, W-LAN (wireless LAN)] in order to implement a network diversity service.

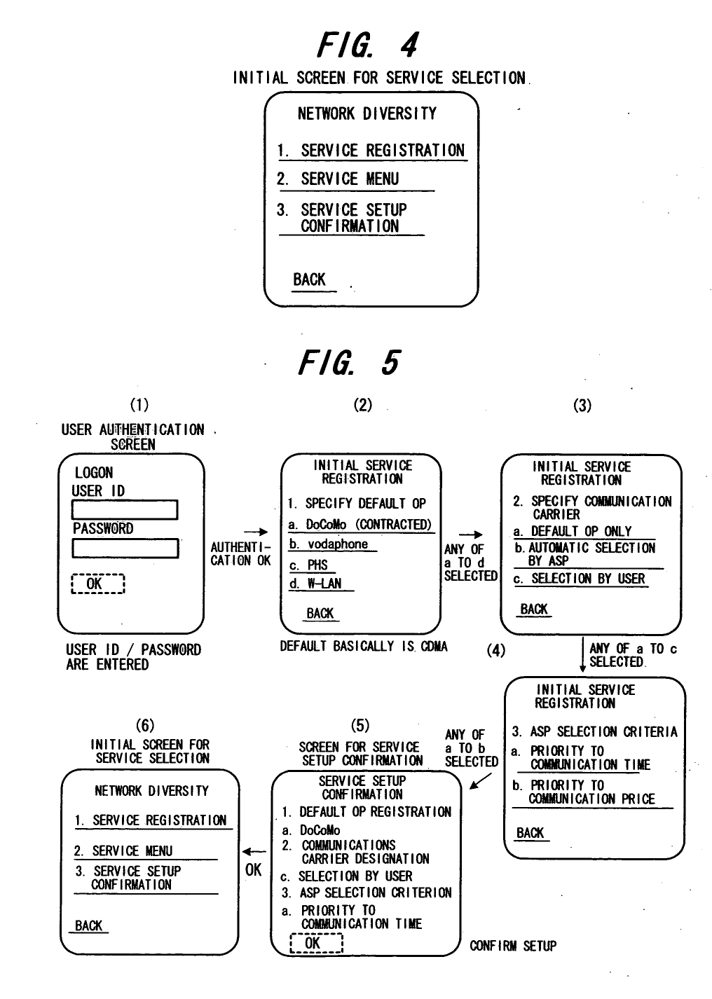

(2) The mobile information terminal 11 possesses a function whereby the user who has this terminal performs initial service registration of information necessary for deciding the network, and a function whereby the ASP 13 is notified of information that has been registered (see FIGS. 4 and 5). This is a procedure for initial service registration.

(3) The mobile information terminal 11 possesses a function for recognizing radio environmental conditions of the selected network and reporting the radio conditions (e.g., the RSSI) to the ASP 13 at the volition of the user or automatically.

(4) The mobile information terminal 11 possesses a function for receiving information indicating the nature (content) or characteristics of communication with the communicating party, and a function for notifying the ASP of this information.

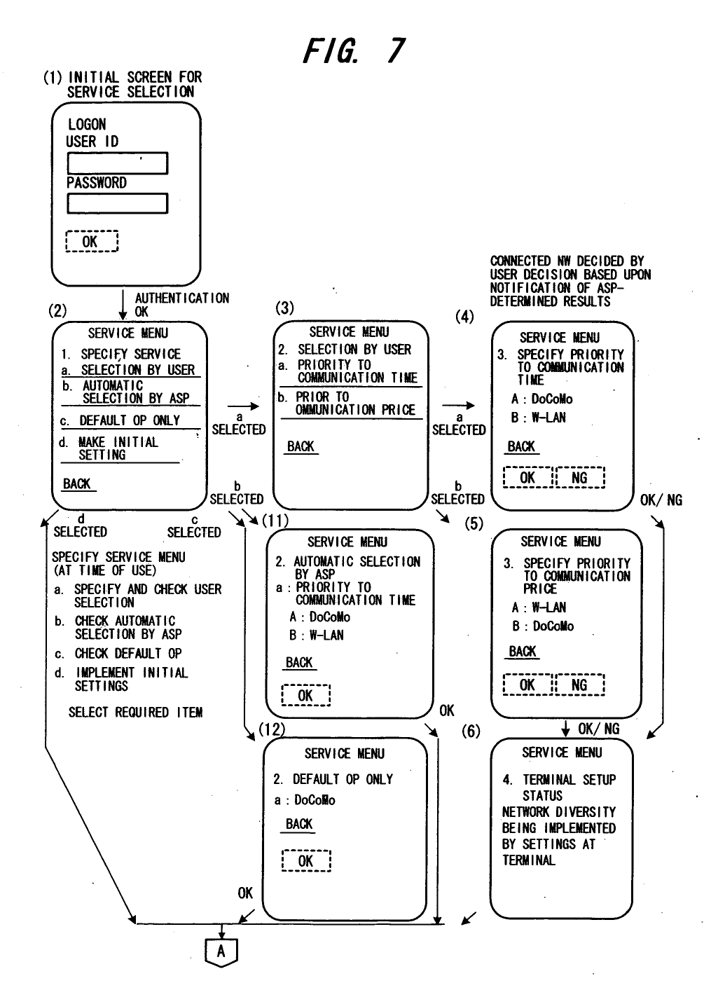

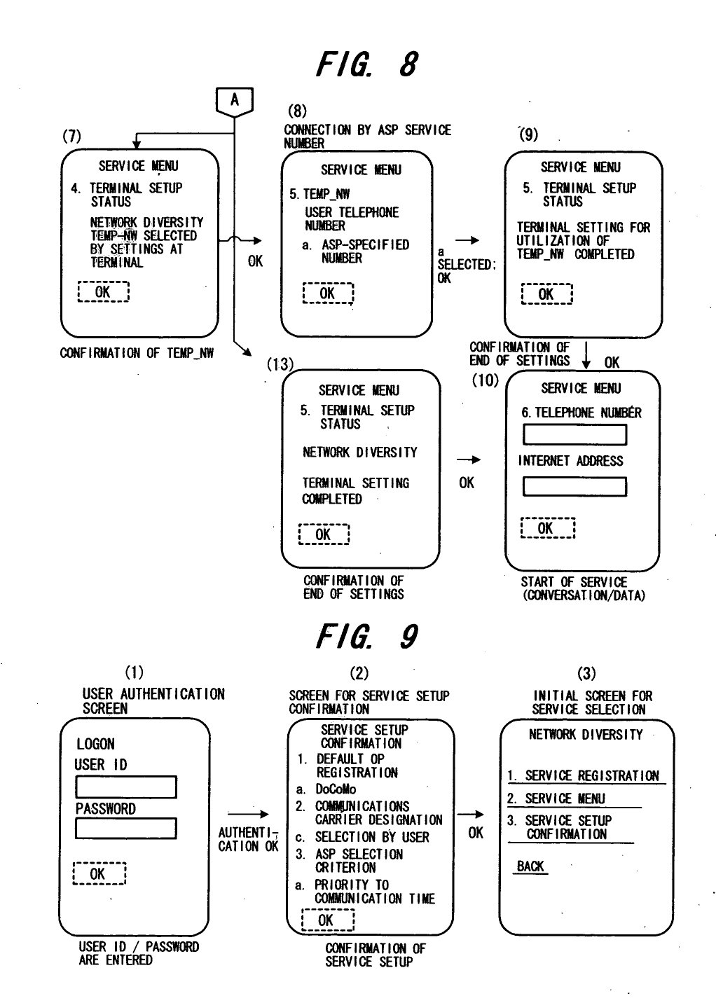

(5) The mobile information terminal 11 possesses a function for receiving an indication of the network decided by the ASP 13 and displaying it on the terminal, a function for reflecting the intentions of the user in this notification, and a function for reporting user intentions to the ASP (see FIGS. 7 and 8). On the basis of user intentions, the ASP 13 decides the network to be utilized in communication. This is a network decided by the user.

(6) As an example of an application, the mobile information terminal 11 has a function for recording the radio communication conditions between the network that is the object of selection and the terminal, and a function for comparing a network environment that includes the radio environmental conditions of the network to which the communicating party is connected and autonomously deciding, based upon the result of the comparison, a network having the matching communication capability.

(C) Initial Service Registration

The user must register a service with the ASP 13 in order to receive the network diversity service. FIG. 4 illustrates an example of an initial screen for service selection on a mobile information terminal. If the network diversity service is selected from a menu (not shown) on the mobile information terminal 11, the menu for the network diversity service (the initial screen) of FIG. 4 is displayed. The user therefore selects the service registration menu item. It should be noted that “Service Registration” of item 1 is a menu item for initially registering service with the ASP, “Service Menu” of item 2 is a menu item for implementing the actual network diversity service, and “Service Setup Confirmation” of item 3 is a menu item for checking the service settings.

FIG. 5 illustrates examples of display screens showing a procedure for initial service registration. If “Service Registration” is selected in FIG. 4, the ASP displays a screen, which is shown at (1) in FIG. 5, for allowing authentication of the user. If a user ID and password are entered and authentication is OK, then the ASP displays a screen (2) for specifying a default OP (default network). The user responds by selecting a default network. Ordinarily, CDMA is the default network. If a prescribed default network is selected, then the ASP displays a screen (3) for specifying a communications carrier. Using the screen (3) for specifying a communications carrier, the user specifies (a) whether to communicate solely with a specified default contracted communications carrier, (b) whether to decide the communicating network by automatic selection by the ASP in a case where communication with two or more networks is possible, or (c) whether to select the communicating network by user selection in a case where communication with two or more networks is possible.

When the designation of the communications carrier has been completed, the ASP displays a screen (4) of selection criteria. Using the screen (4), the user selects (a) whether to decide the communicating network or network candidate giving priority to communication time or (b) whether to decide the communicating network or network candidate giving priority to communication cost.

If the selection on screen (4) of selection criteria has been completed, then the ASP displays a screen (5) for checking service settings and displays the items that were set at (2) to (4). FIG. 5 displays a case where “DoCoMo” has been selected as the default OP, “SELECTION BY USER” as the communications carrier and “PRIORITY TO COMMUNICATION TIME” as the ASP selection criterion. If an “OK” key is clicked on the screen (5) for checking service settings, then the screen returns to the initial screen (6) for service selection.

The foregoing operation completes initial registration for receiving the network diversity service.

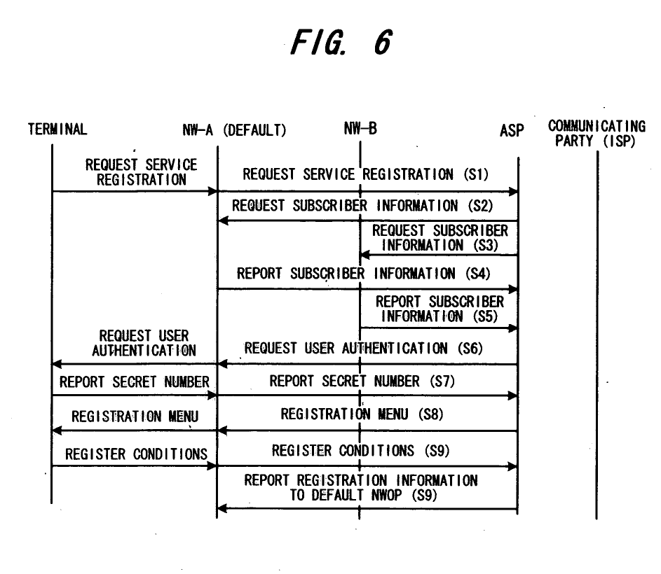

FIG. 6 illustrates a sequence in initial service registration. The sequence is composed of the following steps:

(1) The user introduces power to the terminal.

(2) The user selects the menu for network diversity.

(3) Connection to the ASP server is completed.

(4) The ASP receives a service registration request from the terminal (S1).

(5) The ASP requests the communications carrier (NWOP) for notification of subscriber information (S2, S3).

(6) The ASP acquires subscriber information from each NWOP (S4, S5).

(7) The ASP transmits a user authentication request to the terminal (S6).

(8) The user enters a user ID and a secret number

(9) The ASP checks authentication (S7).

(10) The ASP sends the terminal the menu for initial service registration (S8).

(11) The user makes the default setting (voice/data default communications carrier), specifies the communications carrier and specifies the ASP selection criterion (S9: condition registration).

(12) The user specifies an automatic bill-paying account (the automatic bill-paying account of the default communications carrier) (S9).

(13) The ASP completes registration.

(14) The ASP sends the terminal the menu for checking the service settings.

(15) The user checks the settings and selects “OK”.

(16) The ASP reports registration information to the default NWOP (S10).

(D) Procedure for Starting Implementation of Service

FIGS. 7 and 8 are diagrams useful in describing a procedure for starting implementation of service.

When the user selects the network diversity service and the initial screen of FIG. 4 is displayed, the user selects “SERVICE MENU” and enters service implementation. As a result, the ASP displays a user authentication screen (1) in FIG. 7 on the display unit of the mobile information terminal. If the user enters a user ID and password and authentication is OK, then the ASP displays a service designating screen (2). If “SELECTION BY USER”, however, has already been selected by an initial setting, then the ASP displays a user selection screen (3). However, if “PRIORITY TO COMMUNICATION TIME” has already been selected by an initial setting, then the ASP decides and displays two network candidates (DoCoMo and W-LAN in the example of FIG. 7) through which communication is possible while giving priority to communication time [a screen (4) for specifying priority to communication time)]. If “PRIORITY TO COMMUNICATION PRICE” has been selected by an initially setting, then the ASP decides two network candidates (first candidate: WLAN; second candidate: DoCoMo) through which communication is possible while giving priority to communication price and displays a screen (5) for specifying priority to communication price.

On screen (4) for specifying priority to communication time, OK is entered if the first candidate DoCoMo is acceptable and NG is entered if the second candidate W-LAN is acceptable. If this is done, then the ASP displays a screen (7) showing the terminal settings and displays that a network (e.g., TEAM-NW) has been selected. If “OK” is entered, the ASP displays a screen (8) of the user's telephone number. This screen displays whether it is acceptable to issue a connection request by the ASP-specified telephone number (the ASP service special number)). If this is “OK”, then the ASP displays a screen (9) of terminal settings, which displays that the setting of the utilized network has been completed. If “OK” is entered here, then the ASP displays the service special number on a screen (10) for displaying a telephone number. By entering “OK”, a connection request is issued to the above-mentioned utilized network that has been set, the connection is made and conversation and data communication is started or handover is completed.

On the other hand, if “AUTOMATIC SELECTION BY ASP” has been selected by an initial setting, then the ASP displays a screen (11) of automatic selection by the ASP. Further, if “DEFAULT OP ONLY” has been selected by an initial setting, then the ASP displays the default OP (default network) on a default OP screen (12). If “OK” is entered on screen (11) or (12), then the ASP displays a screen (13) of terminal settings, which displays that a network has been selected. If “OK” is entered here, then the ASP displays a screen (10) for displaying a telephone number. Next, using the screen (10), the user enters a telephone number and starts conversation or enters an Internet address and starts data communication.

If initial service registration has not been performed and “d. MAKE INITIAL SETTING” has been selected on screen (2), then initial service registration is carried out.

FIG. 9 illustrates examples of screens showing a procedure for confirming service settings. If “CHECK SERVICE SETTINGS” has been selected on the initial screen of FIG. 4, then the ASP displays a user authentication screen (1) in FIG. 9 on the display unit of the mobile information terminal. If the user enters a user ID and password and clicks “OK for authentication, then the ASP displays a screen (2) for checking service settings. If “OK” is entered here, then the screen returns to the initial screen of FIG. 4.

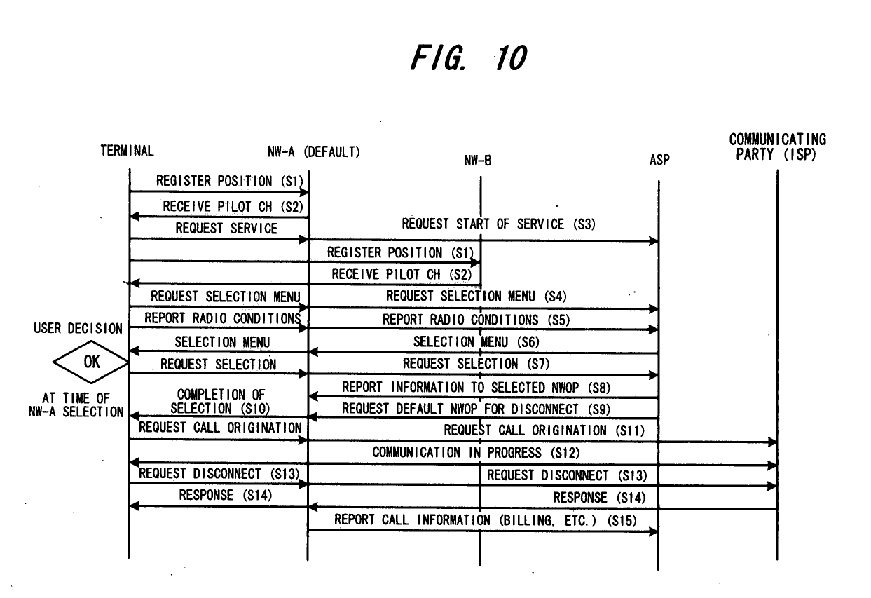

FIG. 10 illustrates a sequence in a case where a network is decided by the “user selection scheme” in implementation of a network diversity service. This sequence is composed of the following steps:

(1) The user introduces power to the terminal.

(2) Position registration is performed and Pilot CH is received (S1, S2).

(3) The user requests the ASP to start the service (S3).

(4) The user requests the ASP server for a selection menu (S4).

(5) The user notifies the ASP server of the radio conditions (S5).

(6) The ASP recognizes the request for the selection menu, compares the radio conditions of the networks and reports the selection menu to the mobile information terminal (S6).

The selection menu (network candidates) is displayed on the mobile terminal.

(7) A network (NW-A) is selected by user selection and a selection request is reported to the ASP.

(8) Information is reported from the ASP to the network (NW-A) (S8).

(9) A disconnect request is issued to the default NWOP (S9).

(10) The mobile information terminal is notified of completion of selection (S10).

(11) An outgoing-call request to the communicating party is issued from the mobile information terminal via the network (NW-A).

By virtue of the operation above, it becomes possible for the mobile information terminal and communicating party to communicate (S12).

It should be noted that if the network (NW-A) is a WLAN, then, at S11, the user sets up a WLAN-NW call, establishes a WLAN-NW communication connection by an IP address and then enters the IP address of the communicating party to start communication. Further, if the network (NW-A) is CDMA, then, at S11, the user sets up a CDMA-NW call, establishes a CDMA-NW communication connection by a telephone number and then enters the telephone number of the communicating party to start communication.

(12) If communication has ended, then a disconnect request is issued from the mobile information terminal to the network (NW-A) and from the network (NW-A) to the communicating party (S13).

(13) A disconnect response is sent from the communicating party to the network (NW-A) and from the network (NW-A) to the mobile information terminal (S14).

(14) Following the completion of disconnect, the network (NW-A) reports call information (billing information, etc.) to the ASP (S15).

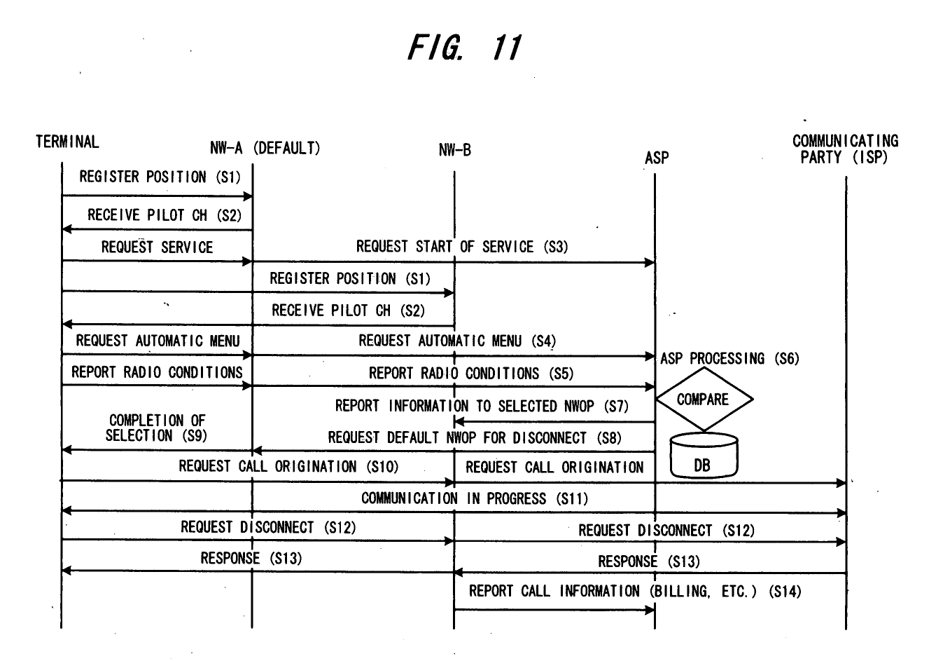

FIG. 11 illustrates a sequence in a case where a network is decided by the “ASP automatic selection scheme” in implementation of a network diversity service. The sequence is composed of the following steps:

(1) The user introduces power to the terminal.

(2) Position registration is performed and Pilot CH is received (S1, S2).

(3) The user requests the ASP to start the service (S3).

(4) The user requests the ASP server for an automatic menu (S4).

(5) The user notifies the ASP server of the radio conditions (S5).

(6) The ASP recognizes the request for the automatic menu, compares the radio conditions of the networks and decides the optimum network automatically (S6).

(7) Information is reported to the automatically decided network (NW-B) (S7).

(8) A disconnect request is issued to the default NWOP (S8).

(9) The mobile information terminal is notified of completion of selection (S10).

(10) An outgoing-call request to the communicating party is issued from the mobile information terminal via the network (NW-B).

By virtue of the operation above, it becomes possible for the mobile information terminal and communicating party to communicate (S11).

(11) If communication has ended, then a disconnect request is issued from the mobile information terminal to the network (NW-B) and from the network (NW-B) to the communicating party (S12).

(12) A disconnect response is sent from the communicating party to the network (NW-B) and from the network (NW-B) to the mobile information terminal (S13).

(13) Following the completion of disconnect, the network (NW-B) reports call information (billing information, etc.) to the ASP (S14).

(E) Functions of ASP for Implementing Network Diversity Service

The ASP has the following functions in order to implement the network diversity service:

(1) User Registration

The ASP has a function for allowing the mobile information terminal to perform initial service registration and a function for changing registration. More specifically, at the time of initial service registration or when registered content is changed, the ASP functions to. send the mobile information terminal information, which is for seeking a selection from the user, together with a list of registered content, receive a reaction from the user in response to this and record the reaction.

(2) Changing user Information

The ASP has a function for receiving a request from the service user to change the operating state of the registered service to a state such as “change”, “sleep”, “cancel” and “start”.

(3) Updating, Maintaining and Managing User Information Database

The ASP has a function for accepting, maintaining and managing information registered by the user and a request such as a change of registered content.

(4) Maintaining and Managing Communication Characteristics

The ASP has a function for accepting, maintaining and managing information indicating the user of the service, the communicating party and the characteristics and attributes of the content of this communication.

(5) Maintaining and Comparing Radio Environment Conditions

The ASP has a function for accepting, recording and comparing the radio environment conditions of a plurality of networks to undergo comparison.

(6) Network Decision Processing

The ASP has an address managing function in order to execute call set-up processing in a different network transparency and is adapted to correlate addresses, identifiers and telephone numbers that bridge different networks and continue communication with the different network based upon the identifier.

(7) Autonomously deciding Network Utilized

The ASP has a function for deciding a network that is optimum for economical and efficient utilization based upon the radio environment conditions of the networks to undergo comparison, a change in location information of the mobile information terminal and the characteristics of the nature of communication with the communicating party.

(8) Call Connection to Network Decided

The ASP has a function for setting up a call between the mobile information terminal of the service user and the communicating party via the network decided.

(9) Call Set-Up when Autonomous Decision of Network is Difficult

Under circumstances where autonomous decision of the network has been determined to be difficult, the ASP decides the utilized network in accordance with registered content specified by the service user in advance and sets up a call between the terminal of the service user and the communicating party.

(10) Notification of Result of Comparison for Deciding Network

The ASP has a function for notifying the terminal of the service user of the result obtained.

(11) Acceptance of user Intent with Regard to Utilization of Network

The ASP has a function for accepting and recording the reaction of the service user to the result reported and for setting up a call to the communicating party in accordance with the intent of the reaction.

(12) Server-System Settlement Intermediary Function regarding user Billing

The ASP has a function for mediating settlement of accounts necessary with regard to the communications carrier in utilization of the service.

(F) ASP Processing Function Block

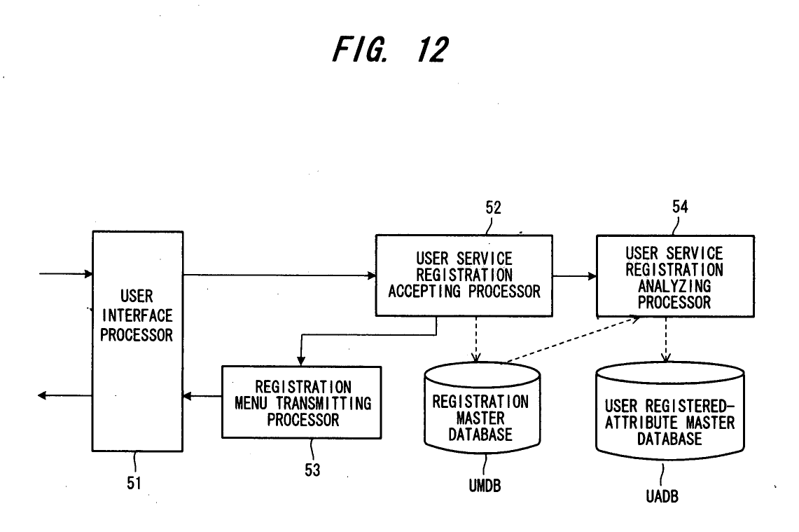

FIG. 12 is a functional block diagram of service registration processing executed by the ASP. The ASP performs user service registration, user service management and user address management.

A user interface processor 51 sends and receives information to and from mobile information terminal 11 or terminal 14 through the network 12 and the Internet 15 and delivers received data to the corresponding processor in accordance with the content of the data received.

A user service registration accepting processor 52 accepts requests for new service registration, change, service start, temporary stop and cancellation and causes a registration menu screen (FIGS. 4 to 8) to be displayed on the display unit of the terminal via a registration menu transmitting processor 53. Further, the user service registration accepting processor 52 stores data, which has been received from the mobile information terminal, in a user registration master database UMDB as new registration data or updates existing registration data based upon the received data. To change registered content, the mobile information terminal connected to the ASP 13 is sent information, which is for seeking a change from the user, together with a list of registered content, and a reaction from the user to this information is received and recorded.

A user service registration analyzing processor 54 classifies users attribute by attribute based upon data in the user registration master database UMDB and stores the results in a user registered-attribute master database UADB. That is, the user service registration analyzing processor 54 appropriately classifies received and recorded information from the mobile information terminal 11 and records it inclusive of past history.

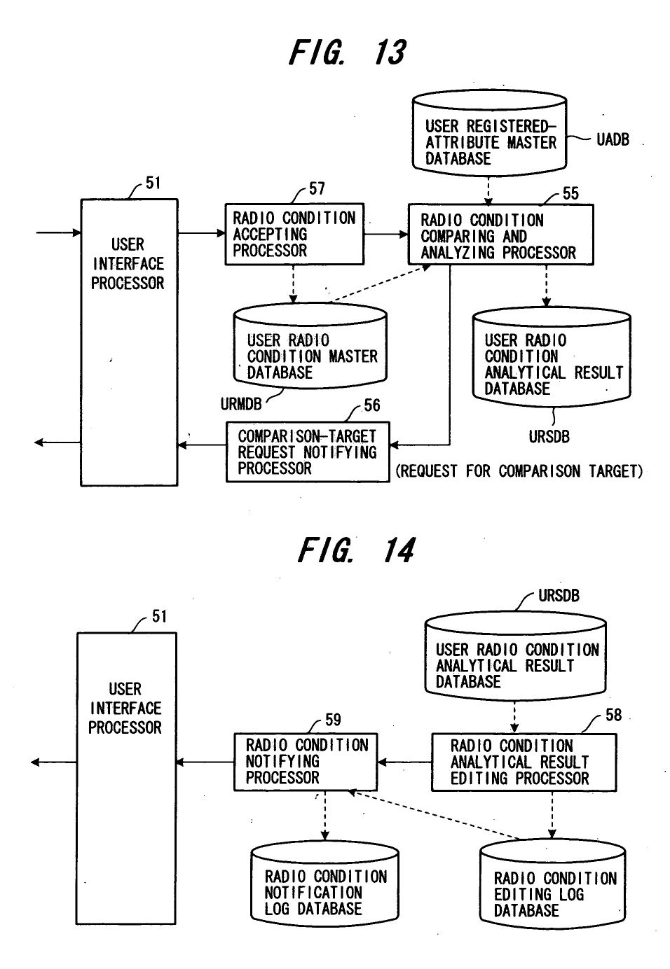

FIG. 13 is a functional block diagram illustrating processing executed by the ASP for comparing and analyzing radio conditions.

A radio condition comparing and analyzing processor 55 obtains a comparison target network, which is to undergo comparison, based upon registered data in the user registered-attribute master database UADB, and requests the radio condition of the comparison target network to a comparison-target request notifying processor 56. In response, the processor 56 reports the comparison target network to the mobile information terminal of interest. The terminal measures the radio condition [the RSSI (dBm)] of the comparison target network of which it has been notified and inputs the result to the ASP. A radio condition accepting processor 57 stores the radio condition [the RSSI (dBm)] of the network received from the terminal in a user radio condition master database URMDB. The radio condition comparing and analyzing processor 55 compares and analyzes the radio condition of the comparison target network that has been stored in the user radio condition master database URMDB and stores the result of analysis in a user radio condition analytical result database URSDB.

It should be noted that processing for comparing and analyzing each radio condition involves making a comparison between mobile communication networks using the RSSI and selecting the largest value. Between WLANs (wireless LANs), the RSSI value is found by calculation from the position of the access point AP of a hot spot and the position of the mobile information terminal, a comparison is performed in similar fashion and the WLAN exhibiting the largest value is selected.

FIG. 14 is a functional block diagram of processing for reporting results of comparison.

A radio condition analytical result editing processor 58 compares and analyzes the radio condition of each network, uses the result to edit the content (selection menu) of the analytical result in parallel with display on the user terminal and transmits the edited results to a radio condition notifying processor 59. At this time the radio condition analytical result editing processor 58 creates a radio condition editing log and the radio condition notifying processor 59 creates a radio condition notification log.

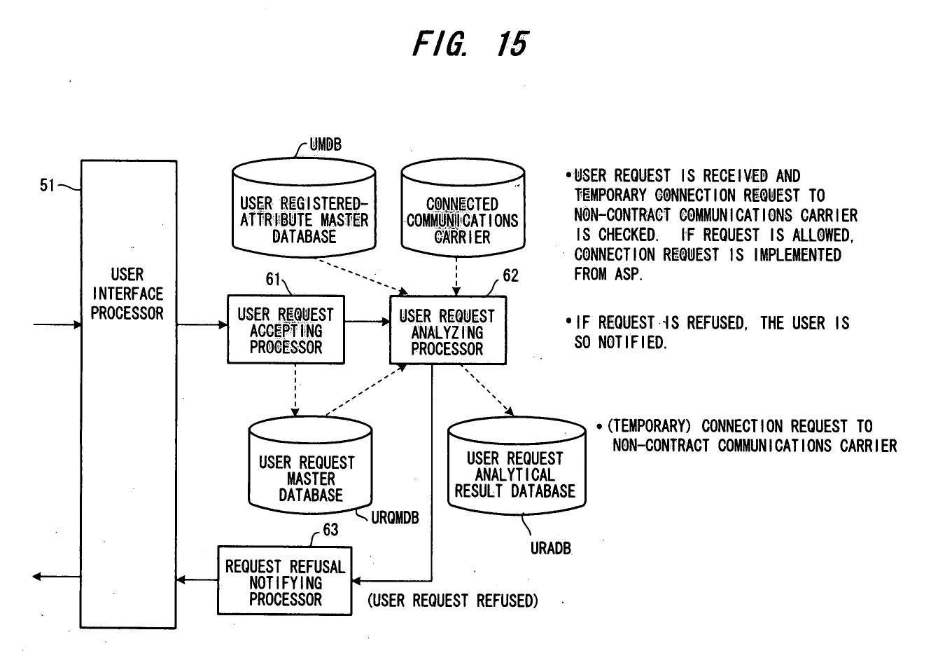

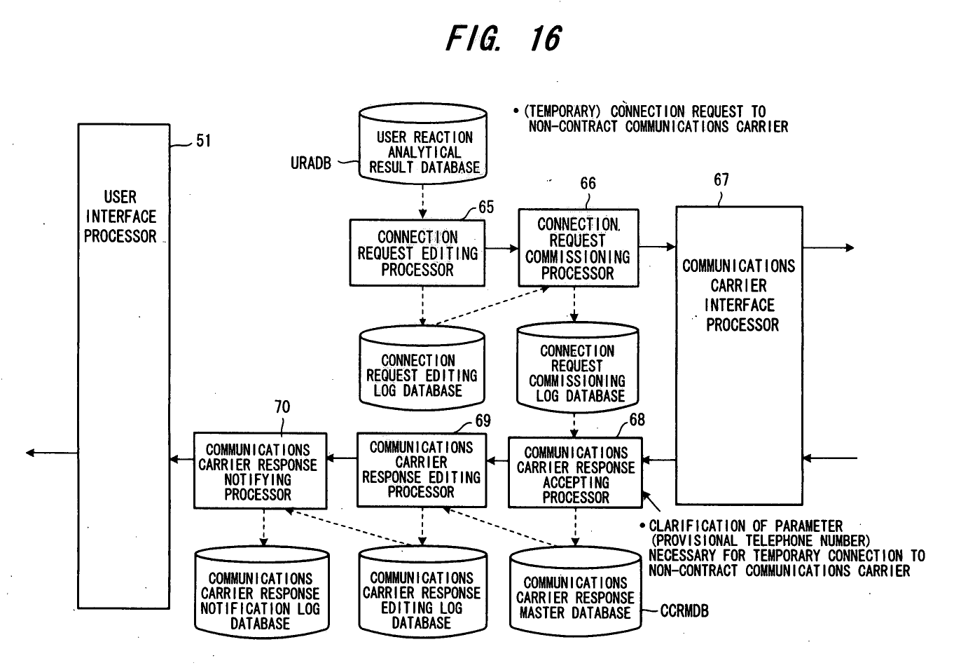

FIG. 15 is a functional block diagram illustrating (temporary) connection-request processing for issuing a connection request to a communications carrier with which the user has no agreement. A user request accepting processor 61 receives a connection request from the user and creates a user request master database URQMDB, and a user request analyzing processor 62 refers to the user request master database URQMDB and the user registration master database UMDB and, if the user request is a request for connection to a non-contract communications carrier, checks the temporary connection request to the non-contract communications carrier. If the request is allowed, the processor 62 requests the non-contract communications carrier for connection by processing illustrated in FIG. 16. Further, the user request analyzing processor 62 stores the result of analysis in a user request analytical result database URADB. If the connection request has been refused, the processor 62 so notifies the user via a request refusal notifying processor 63.

FIG. 16 is a functional block diagram illustrating processing for connecting/responding to a non-contract communications carrier. A connection request editing processor 65 refers to the result of analyzing user requests stored in the user request analytical result database URADB and, if a connection request is a request for connection to a non-contract communications carrier, creates a connection request editing log. A connection request commissioning processor 66 sends a connection request to the communications carrier via a communications carrier interface processor 67 based upon the log and creates a connection request commissioning log.

Since the communications carrier is sent, in response to the connection request, a parameter such as a provisional telephone number necessary for connection to a non-contract communications carrier, a communications carrier response accepting processor 68 creates a communications carrier response master database CCRMDB, a communications carrier response editing processor 69 creates a communications carrier response editing log, and a communications carrier response notifying processor 70 creates a communications carrier response notification log by referring to this log and reports a parameter such as a provisional telephone number of the user.

(G) Basic Process of Mobile Information Terminal

(a) Process from Initial State

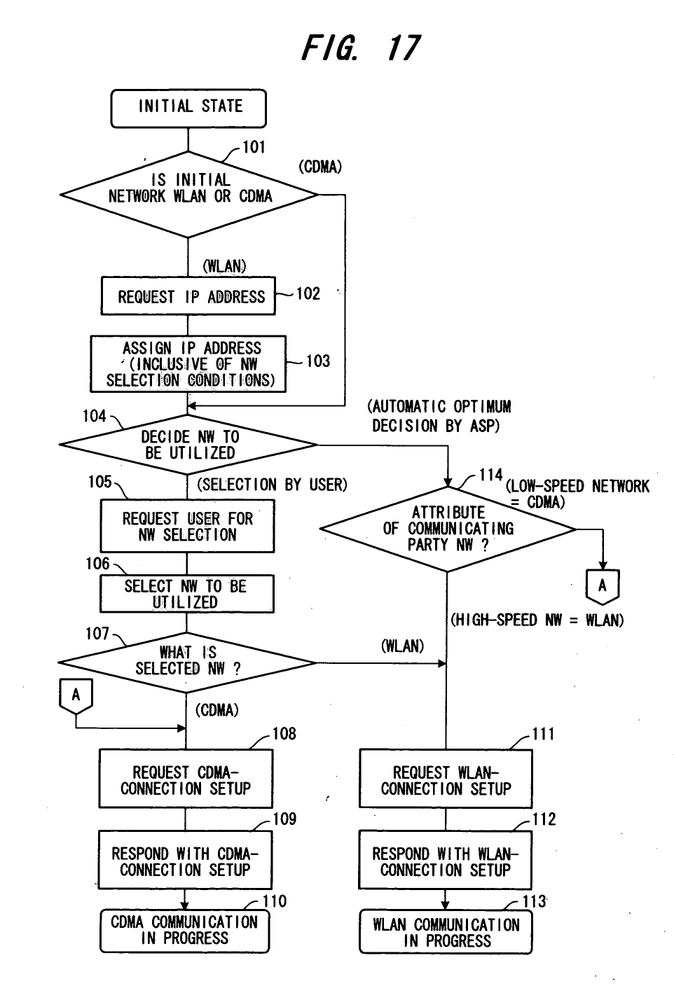

FIG. 17 is a first processing flowchart illustrating the basic process of network diversity at a mobile information terminal. The flowchart illustrates a process from the initial state to the communicating state. It is assumed that there are two networks, namely a CDMA network and WLAN network and that an inclusion relation of the kind shown in FIG. 3 exists with regard to the service area. The number of networks, however, is not limited to two.

When power has been introduced to the mobile information terminal, the terminal is placed in an idle state. In the idle state, the user identifies whether the initial network utilized (the default network) is WLAN or CDMA.

If the initial network utilized is WLAN (step 101), then the mobile information terminal requests the ASP for an IP address (step 102) and receives the IP address from the ASP (step 103). Next, the mobile information terminal identifies by the initial service registration (FIG. 5) whether the scheme is the “user selection scheme” or the “ASP automatic selection scheme” (step 104). If the scheme is the user selection scheme, then the terminal displays two networks (CDMA, WLAN) via which communication is possible and requests the user to select the network (step 105). The user selects either of these networks (step 107). If the selected network is CDMA, then the terminal executes a well-known procedure for setting up a CDMA connection (issues a CDMA-connection setup request and a CDMA-connection setup response) (steps 108, 109) and starts communication with the communicating party by CDMA (step 110).

If it is found at step 107 that the selected network is WLAN, then the terminal executes a well-known procedure for setting up a WLAN connection (issues a WLAN-connection setup request and a WLAN-connection setup response) (steps 111, 112) and starts communication with the communicating party by WLAN (step 113).

If the ASP automatic selection scheme has been selected at step 104, then the terminal examines the attributes of the network of the communicating party (step 114). When the attribute of the communicating-party NW is indicative of low speed, the network (NW) utilized is made CDMA. If the attribute is indicative of high speed, then NW utilized is made WLAN. Cost effectiveness is enhanced by making the conditions of the NW utilized conform to the NW of the communicating party. This is followed by executing CDMA-connection setup processing from step 108 onward if the network is CDMA and executed WLAN-connection setup processing from step 111 onward if the network is WLAN.

(b) Process During Communication

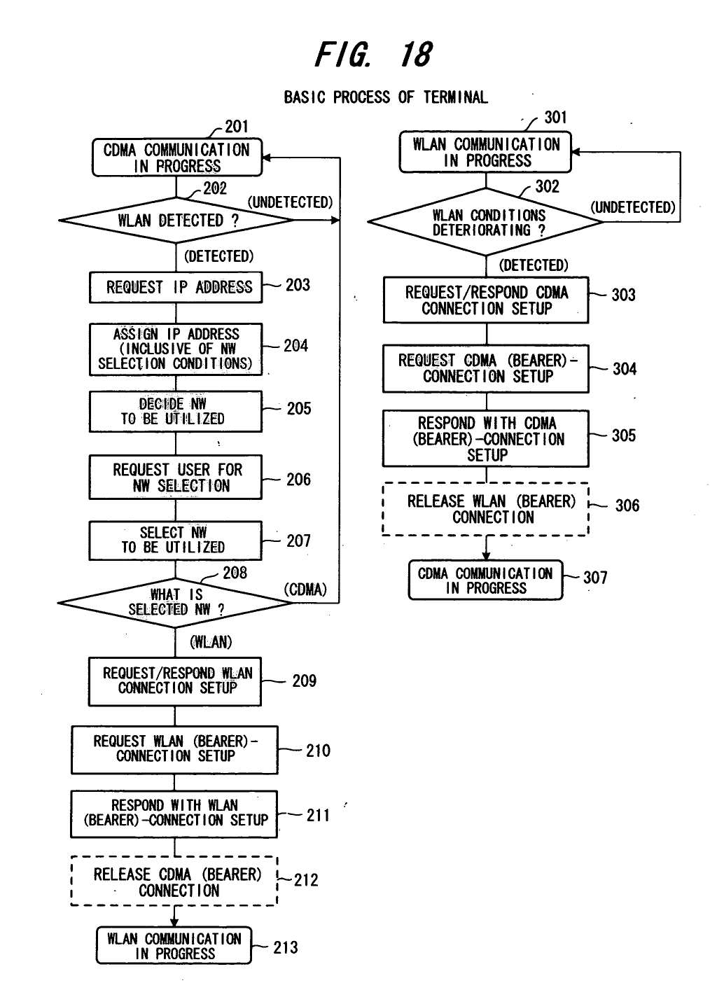

FIG. 18 is a second processing flowchart illustrating the basic process of network diversity at a mobile information terminal. The flowchart illustrates processing for implementing the network diversity service during communication. It should be noted that in the case of the “user selection scheme”, in which the user decides the network via which communication is to continue, the ASP causes the networks via which communication is to continue to be displayed at the terminal, and the user selects the network. Also in the case of the “ASP automatic selection scheme”, in which the ASP decides the network via which communication is possible, the ASP decides networks that are first and second candidates in order of best suitability, displays the first and second candidates at the terminal and finally adopts that which will acquire user confirmation.

During CDMA communication (step 201), the terminal performs monitoring to determine whether WLAN communication has become possible (whether WLAN radio waves from a hot spot have been detected) (step 202). If WLAN communication becomes possible, then the terminal requests the ASP for an IP address and receives the IP address (step 204). Next, since the ASP presents the networks over which communication is possible and asks about which is to be selected, the user selects the desired network (steps 205 to 207). If the user selects CDMA (step 208), then control returns to step 201 and CDMA communication is continued.

If WLAN is selected (step 208), however, then the mobile information terminal executes a well-known WLAN-connection setup procedure (WLAN-connection setup request/response, WLAN-bearer setup request/response) (steps 209 to 211). After the WLAN connection is completed, the terminal releases the CDMA connection and starts communicating with the communicating party by WLAN (steps 212, 213).

During WLAN communication (step 301), the terminal performs monitoring to determine whether the WLAN communication conditions have deteriorated (step 302). If the conditions are deteriorating, i.e., if the mobile information terminal is leaving the WLAN area, then the mobile information terminal immediately executes a well-known CDMA-connection setup procedure (CDMA-connection setup request/response, CDMA-bearer setup request/response) (steps 303 to 305). After the CDMA connection is completed, the terminal releases the WLAN connection and starts communicating with the communicating party by CDMA (steps 306, 307).

(H) Basic Process of ASP

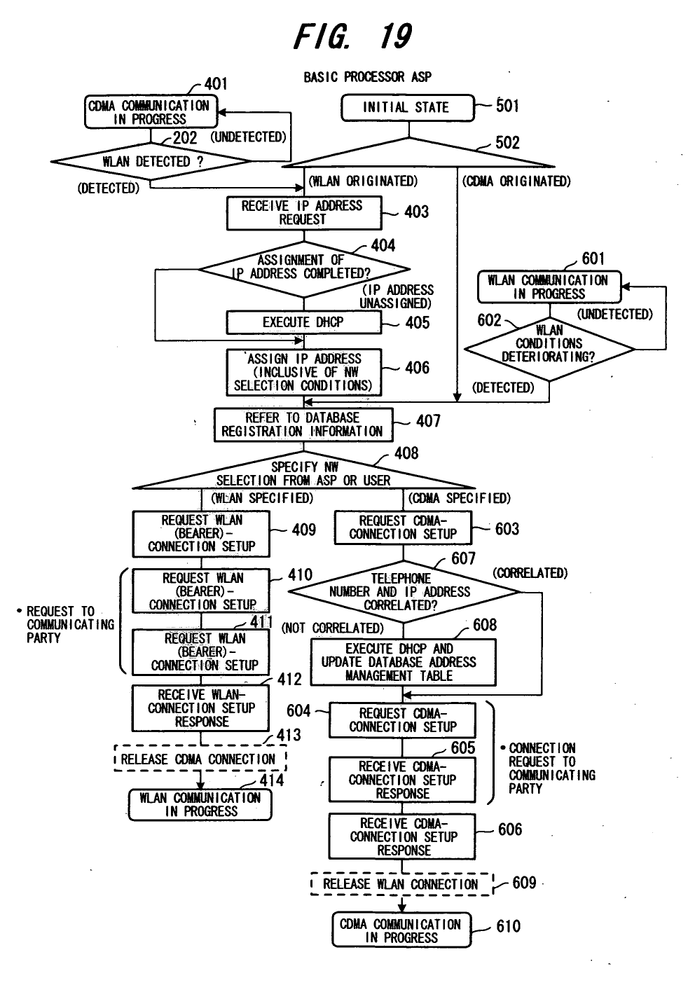

FIG. 19 is a processing flowchart illustrating the basic process of network diversity at the ASP.

During CDMA communication (step 401), the ASP checks to determine whether the mobile information terminal has detected WLAN based upon a report of radio conditions from the terminal (step 402). If WLAN communication is possible, there is a request from an IP address from the mobile information terminal and therefore the ASP receives the request (step 403). Next, the ASP refers to an address management table and checks to see whether the assignment of an IP address has been completed (step 404). If the IP address has not yet been assigned, then the ASP executes a DSCP (Dynamic Hotspot Configuration Protocol), assigns the IP address and updates the address management table (steps 405, 406).

After the IP address is assigned, the ASP refers to a database to see whether the scheme is the “user selection scheme” or “ASP automatic selection scheme” and presents the conforming display at the terminal (step 407). If WLAN is specified by the mobile information terminal (step 408), the ASP executes a procedure for setting up the WLAN connection (steps 409 to 412). After the WLAN connection has been completed, the ASP releases the CDMA connection and starts communicating with the communicating party by WLAN (steps 413, 414). The foregoing is a case where the changeover is from CDMA communication to WLAN communication. However, if a WLAN call has been placed from the mobile information terminal in the initial state in which communication is not in progress (step 501), then WLAN communication starts via steps 403 to 406 and 409 to 412.

During WLAN communication (step 601), the ASP checks to see whether the WLAN communication conditions have deteriorated (step 602). This determination is made based upon the report of radio conditions from the mobile information terminal. If the WLAN communication conditions are poor, then the ASP refers to the database to see whether the scheme is the “user selection scheme” or “ASP automatic selection scheme” and presents the conforming display at the terminal (step 407). If CDMA is specified by the mobile information terminal (step 408), the ASP executes the procedure for setting up the CDMA connection (steps 6003 to 606) and refers to the address management table to determine whether there is correlation between the IP address and telephone number. If there is no correlation, the ASP executes the DHCP, obtains an IP address and effects correlation (updates the address management table in the ASP database (steps 607, 608). After the CDMA connection has been completed, the ASP releases the WLAN connection and starts communicating with the communicating party by CDMA (steps 609, 610). The foregoing is a case where the changeover is from WLAN communication to CDMA communication. However, if a CDMA call has been placed from the mobile information terminal in the initial state in which communication is not in progress (step 502), then WLAN communication starts via steps 603 to 606.

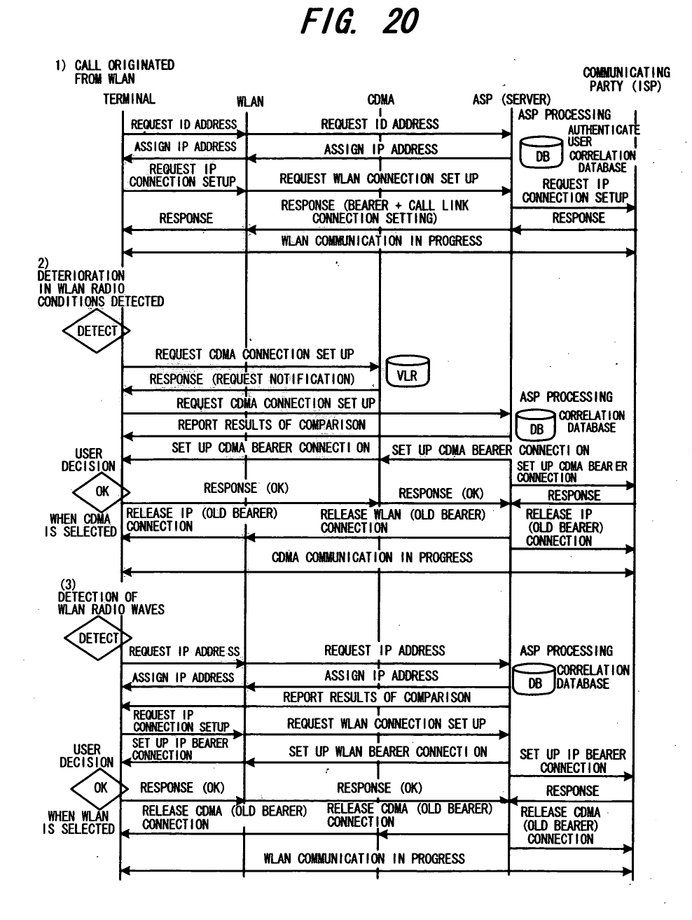

FIG. 20 is a diagram useful in describing a message-flow procedure based upon an IP address utilized in a WLAN network. This diagram corresponds to the processing flow of FIG. 19.

1) When Call Originates from WLAN

In a case where the mobile information terminal originates a call from a WLAN, an IP address is acquired from the ASP and an IP-connection setup request is sent to the WLAN using this IP address. In response, the WLAN sends the ASP a WLAN-connection setup request. Upon receiving the WLAN-connection setup request, the ASP sends an IP-connection setup request to the other party to communication (e.g., an IP provider). If a response is received from this party, the ASP reports this response to the mobile information terminal via the WLAN, after which the mobile information terminal and the other party are placed in communication via the WLAN. The procedure above corresponds to the case where a call is originated from the WLAN in the initial state (step 501) in FIG. 19.

2) When WLAN Communication Conditions Deteriorate during WLAN Communication

If the WLAN communication conditions deteriorate during WLAN communication, the mobile information terminal sends a CDMA-connection setup request to the CDMA network, receives the response, measures the radio condition of the CDMA network and reports the radio condition to the ASP. The ASP compares the radio conditions of the WLAN and CDMA, sends the result of the comparison to the mobile information terminal and sends the CDMA-bearer-connection setup request to the mobile information terminal and to the other party. On the basis of the result of comparison from the ASP, the mobile information terminal seeks confirmation from the user as to whether the CDMA network is acceptable for use as the communication network. If the user enters “OK” in regard to the CDMA network, then the terminal sends a CDMA-bearer-connection setup response to the ASP. If there is also a CDMA-bearer-connection setup response from the other party, then the ASP releases the old bearer connection in use thus far, after which the mobile information terminal and the other party are placed in communication via CDMA.

The procedure above corresponds to the case where the WLAN communication condition deteriorates during WLAN communication (step 601) in FIG. 19 and a transition is made to CDMA communication.

3) When WLAN Radio Waves are Detected during CDMA Communication

If WLAN radio waves are detected during CDMA communication, the mobile information terminal requests the ASP for an IP address. The ASP requests the location information center 17 (FIG. 2) for information concerning the position of the mobile information terminal, specifies the hot spot where the mobile information terminal detected the WLAN radio waves, decides the IP address by DHCP, correlates this IP address with a telephone number and stores the result in the database DB. The ASP thenceforth reports this IP address to the mobile information terminal and reports the result of comparison of the network radio conditions as well. The mobile information terminal subsequently sends an IP-connection setup request to the WLAN using the IP address, and the WLAN sends a WLAN-connection setup request to the ASP. Upon receiving the WLAN-connection setup request, the ASP sends a bearer-connection setup request to the mobile information terminal and to the communicating party. The mobile information terminal displays the network presented by the ASP and seeks confirmation from the user as to whether the CDMA network is acceptable. If the user enters “OK” in regard to the WLAN network, then the terminal sends a bearer-connection setup response to the ASP. If the ASP receives responses from the mobile information terminal and from the other party, then the ASP releases the old bearer connection in use thus far, after which the mobile information terminal and the other party are placed in communication via WLAN.

The procedure above corresponds to the case where the WLAN is detected during CDMA communication and a transition is made to WLAN communication in FIG. 19.

In a case where a call is originated from the WLAN, communication is implemented using an IP address, the radio environment of the WLAN and the CDMA radio environment at the handover destination are checked and the ASP compares and analyzes the radio environments, reports the result of the comparison to the user and seeks a decision. When the user selects a change of communication connection, the communication connection is changed over from the ASP in accordance with the request. It should be noted that when the communication connection is changed over, the ASP maintains the communication connection in effect at the source of the changeover until communication connection at the destination of the changeover is established. This makes it possible to implement a seamless mobility environment.

(I) Service flow

(a) User Selection Scheme

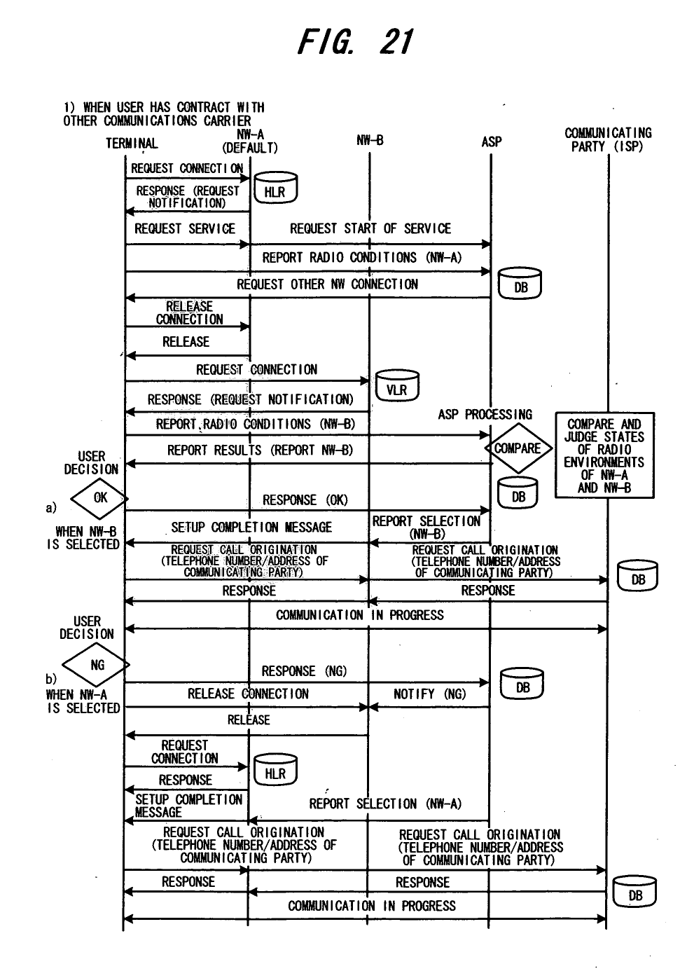

FIG. 21 illustrates service flow in a case where the communications carrier (NWOP) is selected by the user selection scheme. The user has entered into a roaming agreement with another communications carrier within the same area, and the communications carrier (NWOP) utilized can be selected according to the volition of the user based upon results of a comparison.

This service flow is composed of the following steps:

(1) A connection request/response (notification request) is sent/received by the mobile information terminal to/from the NW-A(default NW).

(2) The mobile information terminal sends a service request/service-start request to the ASP.

(3) The mobile information terminal notifies the ASP of the radio conditions of NW-A.

(4) The ASP requests another NW connection.

(5) A connection release/release response is sent/received by the terminal to/from the NW-A.

(6) The terminal sends/receives a connection request/response (notification request) to/from the other network NW-B.

(7) The mobile information terminal notifies the ASP of the radio condition of NW-B.

(8) The ASP executes ASP processing (processing for comparing radio conditions).

(9) The ASP reports the results of comparison (notifies of the NW-B).

(10) The user makes a decision.

(11) The user issues an OK response with regard to the network (NW-B) presented.

(12) The ASP notifies of the NW-B of selection.

(13) The NW-B sends a setup completion message to the mobile information terminal.

(14) The mobile information terminal requests the NW-B for call origination (telephone number/address of communicating party).

(15) The NW-B requests the communicating party for origination of a call (telephone number/address of the communicating party).

(16) The communicating party sends a response to the NW-B, and the NW/B sends a response to the mobile information terminal.

(17) Communication is in progress.

The foregoing is for a case where an OK response is sent to the network NW-B, which is the first candidate that has been presented by the ASP. An NG response can be made and the network NW-A, which is the second candidate, can also be selected. In such case the flow would have the following steps:

(18) An NG response is issued based upon the decision by the user (NW-A is selected)

(19) The ASP notifies NW-B of NG.

(20) The mobile information terminal sends/receives a connection release/release response to/from the NW-B.

(21) The mobile information terminal sends/receives a connection request/connection response to/from the NW-A.

(22) The ASP notifies the NW-A of selection of NW-A, and the NW-A sends a setup completion message to the terminal.

(23) The mobile information terminal sends a call origination request to the NW-A (telephone number/address of the communicating party).

(24) The NW-A sends the call origination request to the communicating party (telephone number/address of the communicating party).

(25) The communicating party sends a response to the NW-A, and the NW/A sends a response to the mobile information terminal.

(26) Communication is in progress.

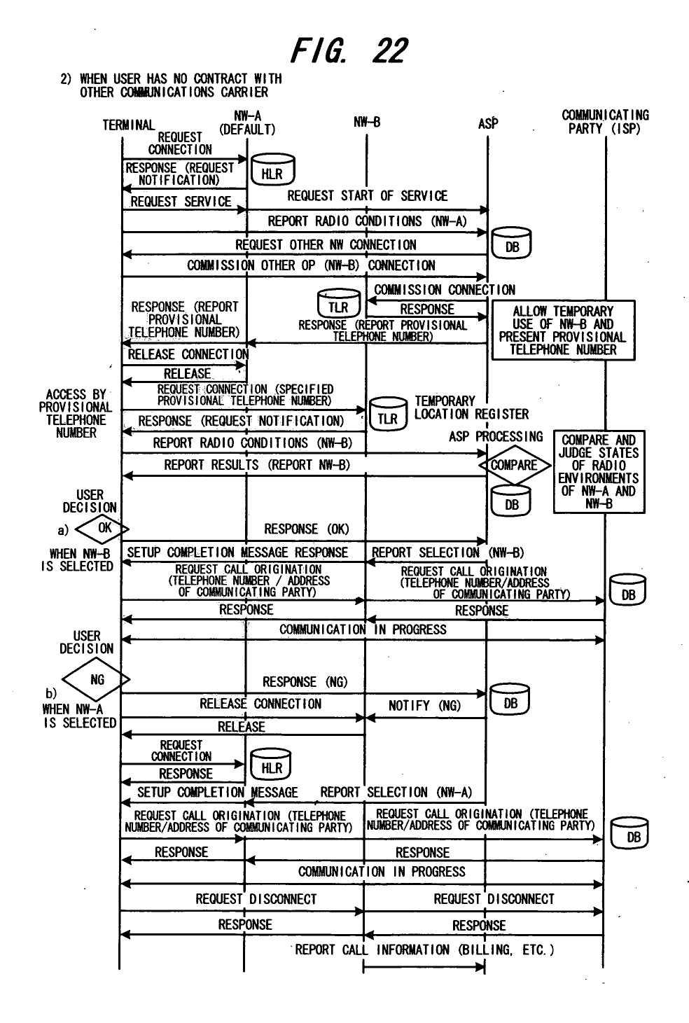

FIG. 22 illustrates service flow in a case where a communications carrier (NWOP) is selected by the user selection scheme. This is a case where the user has not signed a contract with another communications carrier. Here an ASP acts as an intermediary for communication with the non-contract communications carrier. As a result, it is possible for the non-contract communications carrier to increase its revenues, and it is unnecessary for the user to be aware of whether the communications carrier is a contracted or non-contract communications carrier. Further, by virtue of a mechanism whereby the ASP requests the non-contract communications carrier to generate a TLR (Temporary Location Register), it is possible for the user to freely utilize any radio scheme (e.g., a public W-LAN carrier). It is assumed here that the user terminal supports a plurality of radio schemes.

The service flow of FIG. 22 has the following steps:

(1) A connection request/response (notification request) is sent from and received by the mobile information terminal to and from the NW-A (default NW).

(2) The mobile information terminal sends a service request/service-start request to the ASP.

(3) The mobile information terminal notifies the ASP of the radio conditions of NW-A.

(4) The ASP sends the mobile information terminal a request for connection to another NW (NW-B), and the mobile information terminal sends the ASP a request for connection to the other network (NW-B).

(5) The ASP sends/receives a connection request/response to/from the NW-B. The response includes temporary permission to use NW-B and a provisional telephone number.

(6) The ASP responds to the mobile information terminal (notifies of the provisional telephone number).

(7) The mobile information terminal sends/receives a connection release/release response to/from the NW-A.

(8) The mobile information terminal sends/receives a connection request/response to/from the NW-B using the specified provisional telephone number.

(9) The mobile information terminal notifies the ASP of the radio condition of the NW-B.

(10) The ASP executes ASP processing (the ASP executes processing for comparing the radio conditions of the networks NW-A, NW-B).

(11) The ASP reports the results of comparison to the mobile information terminal (notifies of the NW-B).

(12) The user makes a decision.

(13) The user issues an OK response with regard to the network (NW-B) presented.

(14) The ASP notifies of the selection (NW-B).

(15) The ASP notifies the NW-B of the selection, and the NW-B sends a setup completion message to the mobile information terminal.

(16) The mobile information terminal requests the NW-B for call origination (telephone number/address of communicating party).

(17) The NW-B requests the communicating party for origination of a call (telephone number/address of the communicating party).

(18) The communicating party sends a response to the NW-B, and the NW-B sends a response to the mobile information terminal.

(19) Communication is in progress.

The foregoing is for a case where an OK response is sent to the network NW-B, which is the first candidate that has been presented by the ASP. An NG response can be made and the network NW-A, which is the second candidate, can also be selected. In such case the flow would have the following steps:

(20) An NG response is issued based upon the decision by the user at step (12) (NW-A is selected).

(21) The ASP notifies NW-B of NG.

(22) The mobile information terminal sends/receives a connection release notification/release response to/from the NW-B.

(23) The mobile information terminal sends/receives a connection request/connection response to/from the NW-A.

(24) The ASP notifies the NW-A of selection of NW-A, and the NW-A sends a setup completion message to the terminal.

(25) The mobile information terminal sends a call origination request to the NW-A (telephone number/address of the communicating party).

(26) The NW-A sends the call origination request to the communicating party (telephone number/address of the communicating party).

(27) The communicating party sends a response to the NW-A, and the NW/A sends a response to the mobile information terminal.

(28) Communication is in progress.

It should be noted that disconnect is completed by sending a disconnect request from the mobile information terminal to the communicating party via NW-B and sending back a disconnect response from the communicating party to the mobile information terminal via NW-B. After disconnect is completed, the network NW-B notifies the ASP of call information (billing, etc.).

(b) ASP Automatic Selection Scheme

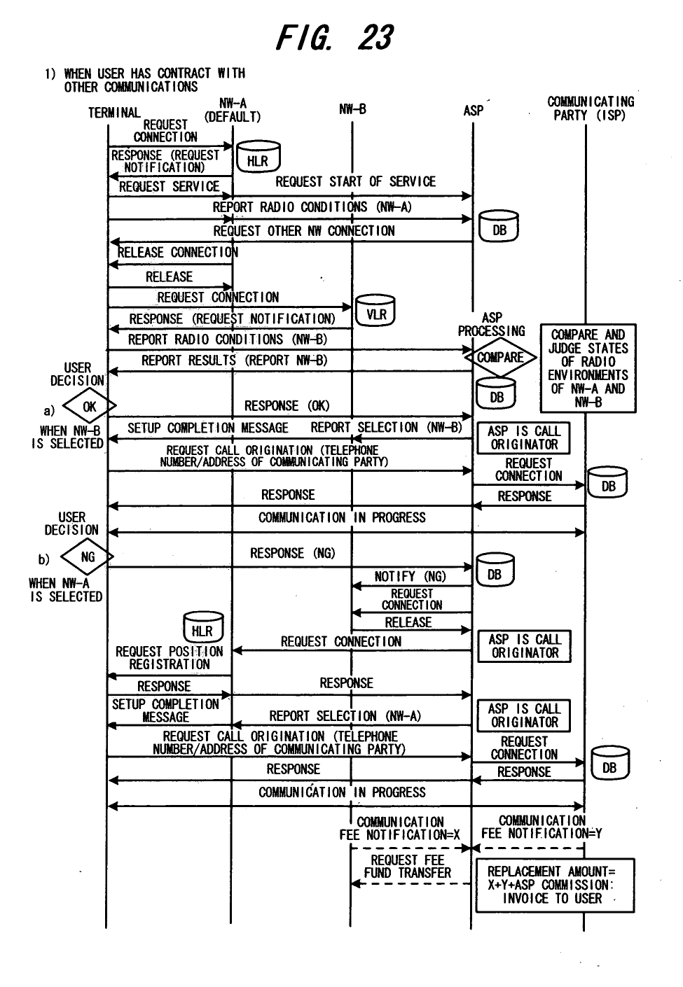

FIG. 23 illustrates service flow in a case where a communications carrier (NWOP) is selected by the ASP automatic selection scheme. This is a case where the user has entered into a contract with another communications carrier. The service flow of FIG. 23 has the steps set forth below. It should be noted that automatically selected networks are displayed at the mobile information terminal and verification by the user is obtained. However, verification by the user is not necessarily required and the related procedure can be omitted.

(1) A connection request/response (notification request) is sent from and received by the mobile information terminal to and from the NW-A (default NW).

(2) The mobile information terminal sends a service request/service-start request to the ASP.

(3) The mobile information terminal notifies the ASP of the radio conditions of NW-A.

(4) The ASP sends the mobile information terminal a request for connection to another NW.

(5) The mobile information terminal sends/receives a connection release/release response to/from the NW-A.

(6) The mobile information terminal sends/receives a connection request/response (notification request) to/from the NW-B.

(7) The mobile information terminal notifies the ASP of the radio condition of the NW-B.

(8) The ASP executes ASP processing (the ASP executes processing for comparing the radio conditions of the networks NW-A, NW-B).

(9) The ASP reports the results of comparison (notifies of the NW-B).

(10) The user makes a decision.

(11) The user issues an OK response with regard to the network (NW-B) presented.

(12) The ASP notifies NW-B of the selection of NW-B.

(13) The NW-B sends a setup completion message to the mobile information terminal.

(14) The mobile information terminal requests the ASP for call origination (telephone number/address of communicating party).

(15) The ASP becomes the call originator and sends a connection request to the other party.

(16) The communicating party sends a response to the ASP, and the ASP sends a response to the mobile information terminal.

(17) Communication is in progress.

The foregoing is for a case where an OK response is sent to the network NW-B, which has been presented by the ASP. An NG response can be made and the network NW-A can also be selected. In such case the flow would have the following steps:

(18) An NG response is issued based upon the decision by the user at step (10).

(19) The ASP notifies NW-B of NG and sends/receives a connection release request/release response to/from the NW-B.

(20) The ASP becomes the call originator and sends a connection request to the NW-A.

(21) The NW-A requests the mobile information terminal for position registration.

(22) The mobile information terminal sends a response back to the NW-A, and the NW-A sends back a response to the ASP.

(23) The ASP notifies the NW-A of the selection of NW-A, and the NW-A sends a setup completion message to the mobile information terminal.

(24) The mobile information terminal requests the ASP for call origination (telephone number/address of communicating party).

(25) The ASP becomes the call originator and sends a connection request to the other party.

(26) The communicating party sends a response to the ASP, and the ASP sends a response to the mobile information terminal.

(27) Communication is in progress.

The items reported at the time of the call origination request are the ID of the communicating party, the NW (communications carrier) selected and the terminal attributes, etc. The ASP notifies the network used of the communication billing statement, charge and the person billed (the user), etc. The basic equation of the charge to the user sought for every call or on a monthly basis is as follows:
charge=X+Y+Z
where X=communication fee of NW-A/B, Y=communication fee of the communicating party, and Z=commission (service charge) of the ASP. Billing is by settlement of accounts between the bands of the respective financial institutions.

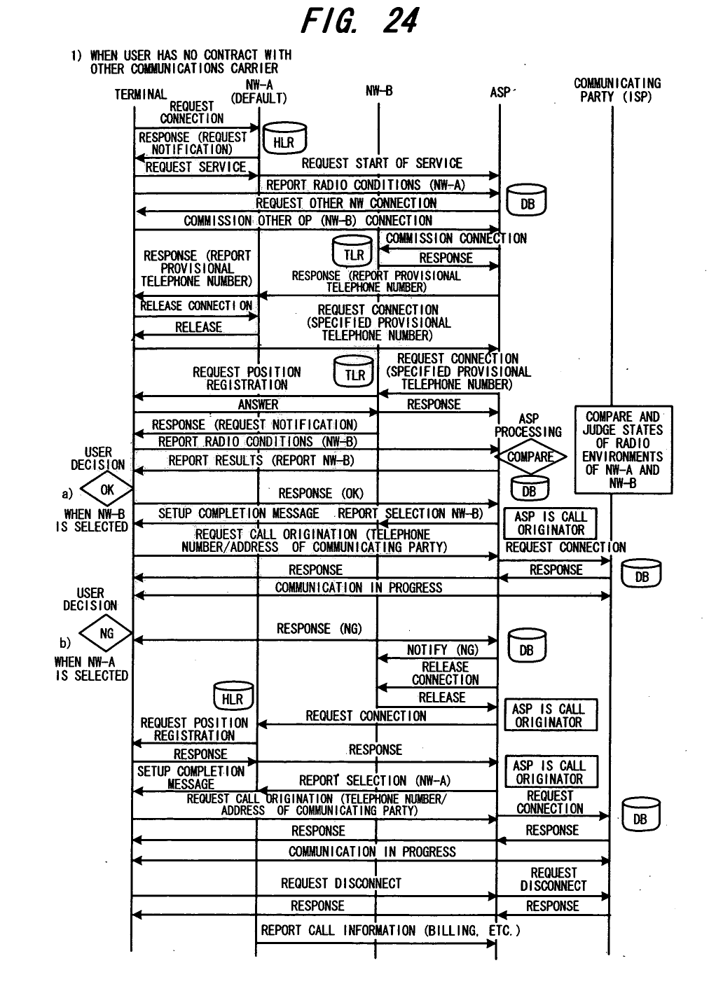

FIG. 24 illustrates service flow in a case where a. communications carrier (NWOP) is selected by the ASP automatic selection scheme. This is a case where the user has not entered into a contract with another communications carrier. The service flow of FIG. 24 is composed of the following steps:

(1) A connection request/response (notification request) is sent from and received by the mobile information terminal to and from the default NW (NW-A).

(2) The mobile information terminal sends a service request/service-start request to the ASP.

(3) The mobile information terminal notifies the ASP of radio conditions.

(4) The ASP sends the mobile information terminal a request for connection to another NW.

(5) The mobile terminal requests the ASP for connection to another network (NW-B).

(6) The ASP sends/receives a connection request/response to/from the NW-B.

(7) The ASP sends the mobile information terminal a response to the connection request (notifies of a provisional telephone number).

(8) The terminal sends/receives a connection release/release response to/from the NW-A.

(9) The terminal requests the ASP for connection by a specified provisional telephone number.

(10) The ASP requests the NW-B for connection by a specified provisional telephone number.

(11) The NW-B requests the mobile information terminal for position registration.

(12) The mobile information terminal sends a response back to the NW-B, and the NW-B sends back a response to the ASP.

(13) The NW-B responds to the terminal (requests notification).

(14) The mobile information terminal notifies the ASP of the radio conditions of the NW-B.

(15) The ASP executes ASP processing (the ASP executes processing for comparing the radio conditions of NW-A, NW-B).

(16) The ASP reports the results of comparison (notifies of the NW-B).

(17) The user makes a decision.

(18) The user issues an OK response with regard to the network (NW-B) presented.

(19) The ASP notifies NW-B of the selection of NW-B.

(20) The NW-B sends a setup completion message to the mobile information terminal.

(21) The mobile information terminal requests the ASP for call origination (telephone number/address of communicating party).

(22) The ASP becomes the call originator and sends a connection request to the other party.

(23) The communicating party sends a response to the ASP, and the ASP sends a response to the mobile information terminal.

(24) Communication is in progress.

The foregoing is for a case where an OK response is sent to the network NW-B, which has been presented by the ASP. An NG response can be made and the network NW-A can also be selected. In such case the flow would have the following steps:

(25) An NG response is issued based upon the decision by the user at step (17).

(26) The ASP notifies NW-B of NG and sends/receives a connection release request/release response to/from the NW-B.

(27) The ASP becomes the call originator and sends a connection request to the NW-A.

(28) The NW-A requests the mobile information terminal for position registration.

(29) The mobile information terminal sends a response back to the NW-A, and the NW-A sends back a response to the ASP.

(30) The ASP notifies the NW-A of the selection of NW-A, and the NW-A sends a setup completion message to the mobile information terminal.

(31) The mobile information terminal requests the ASP for call origination (telephone number/address of communicating party).

(32) The ASP becomes the call originator and sends a connection request to the other party.

(33) The communicating party sends a response to the ASP, and the ASP sends a response to the mobile information terminal.

(34) Communication is in progress.

(c) Settlement Intermediary Function of ASP Regarding Applicable Service

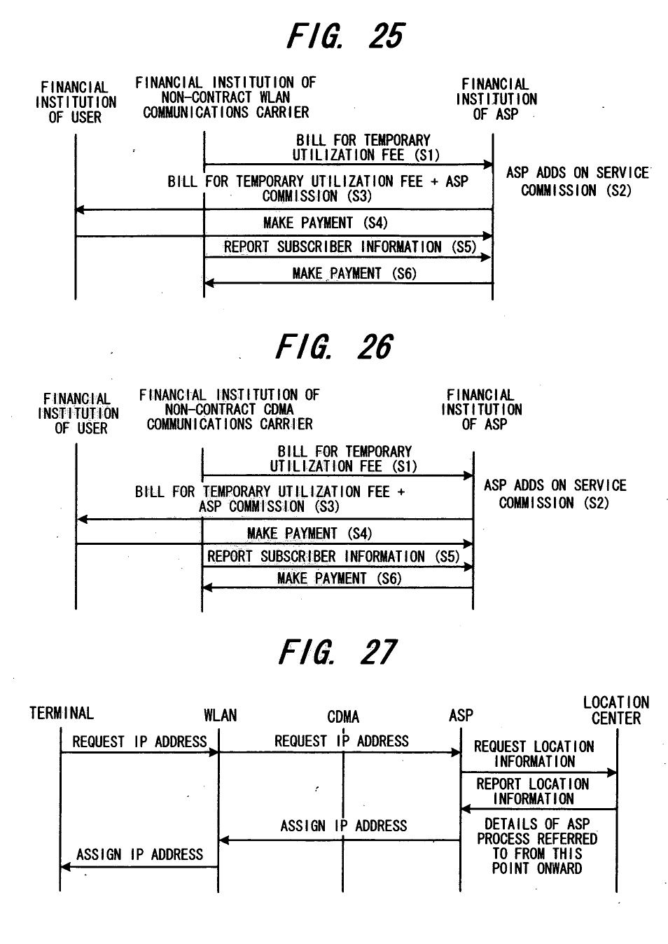

FIG. 25 illustrates a settlement process in a case where a user has utilized a hot spot of a non-contract WLAN carrier.

The financial institution used by the non-contract WLAN carrier bills the financial institution of the ASP for a temporary utilization fee every month, by way of example (S1). The financial institution of the ASP adds a service commission to the billed amount (S2) and invoices the financial institution of the user for the sum (S3). In response, the financial institution of the user makes payment to the financial institution of the ASP (S4). Further, the financial institution of the non-contract WLAN carrier gives notification of subscriber information (S5) and therefore the financial institution of the ASP refers to this subscriber information and makes payment of the temporary utilization fee, which was billed at step S1, to the account of the non-contract WLAN carrier (S6).

Thus, in processing for billing the user, the ASP provides a function for intermediary of settlement of accounts between the financial institution of the user and the financial institution of the of the non-contract communications carrier.

FIG. 26 illustrates a settlement process in a case where a user has utilized a network of a non-contract CDMA carrier.

The financial institution used by the non-contract CDMA carrier bills the financial institution of the ASP for a temporary utilization fee every month, by way of example (S1). The financial institution of the ASP adds a service commission to the billed amount (S2) and invoices the financial institution of the user for the sum (S3). In response, the financial institution of the user makes payment to the financial institution of the ASP (S4). Further, the financial institution of the non-contract CDMA carrier gives notification of subscriber information (S5) and therefore the financial institution of the ASP refers to this subscriber information and makes payment of the temporary utilization fee, which was billed at step S1, to the account of the non-contract CDMA carrier (S6).

Thus, in processing for billing the user, the ASP provides a function for intermediary of settlement of accounts between the financial institution of the user and the financial institution of the of the non-contract communications carrier.

(d) Process when WLAN Radio Waves are Detected

FIG. 27 illustrates an IP address acquisition process in a case where WLAN radio waves have been detected during CDMA NW communication. This corresponds to the case of FIG. 20 where WLAN radio waves have been detected.

As many apparently widely different embodiments of the present invention can be made without departing from the spirit and scope thereof, it is to be understood that the invention is not limited to the specific embodiments thereof except as defined in the appended claims.

1. A utilized-network selection method for a mobile terminal whereby the mobile terminal communicates with a terminal of another party by utilizing a prescribed network from among a plurality of networks, comprising the steps of:
providing a server system connected to each of the networks for exercising control whereby the mobile terminal is allowed to communicate with the other party via a prescribed network;
during communication with the other party by utilizing a first network, detecting another network or detecting deterioration of reception conditions on the side of the mobile terminal;
selecting networks for continuing communication in the server system and presenting these networks to the mobile terminal from the server system when another network is detected or when deterioration of reception conditions is detected;
selecting, on the side of the mobile terminal, a network for continuing communication and reporting this to the server system; and
continuing communication via the selected network under the control of the server system.

2. A utilized-network selection method for a mobile terminal whereby the mobile terminal communicates with a terminal of another party by utilizing a prescribed network from among a plurality of networks, comprising the steps of:
providing a server system connected to each of the networks for exercising control whereby the mobile terminal is allowed to communicate with the other party via a prescribed network;
during communication with the other party by utilizing a first network, detecting another network or detecting deterioration of reception conditions on the side of the mobile terminal;
selecting automatically a network for continuing communication in the server system when another network is detected or when deterioration of reception conditions is detected; and
continuing communication via the selected network under the control of the server system.

3. A communication system having a mobile terminal for communicating with a terminal of another party by utilizing a prescribed network from among a plurality of networks, and a server system connected to each of the networks for exercising control whereby the mobile terminal is allowed to communicate with the other party via the prescribed network, wherein said mobile terminal comprises:
means for detecting another network or deterioration of reception conditions during communication with the other party utilizing a first network;
means for transmitting a service-start request to the server system when another network is detected or when deterioration of reception conditions is detected;
display means for displaying networks presented by the server system; and
means for selecting a network presented by the server system;
wherein the server system responds to the service-start request by obtaining networks for continuing communication and presenting these networks to the mobile terminal;
the network for continuing communication is finally selected and reported to the server system on the side of the mobile terminal; and
communication is continued via the selected network under the control of the server system.

4. A communication system having a mobile terminal for communicating with a terminal of another party by utilizing a prescribed network from among a plurality of networks, and a server system connected to each of the networks for exercising control whereby the mobile terminal is allowed to communicate with the other party via the prescribed network, wherein said mobile terminal comprises:
means for detecting another network or deterioration of reception conditions during communication with the other party utilizing a first network; and
means for transmitting a service-start request to the server system when another network is detected or when deterioration of reception conditions is detected;
wherein the server system responds to the server-start request by selecting a network for continuing communication, and communication is continued via the selected network under the control of the server system.

5. The system according to claim 3, wherein said mobile terminal further comprises a communication unit for communicating in each radio scheme of the plurality of networks.

6. The system according to claim 5, wherein said mobile terminal further comprises:
a detector for detecting radio conditions of each of the networks; and
means for notifying the server system of these radio conditions;
said server system comparing the radio conditions of each of the networks and selecting a network for continuing communication.

7. The system according to claim 3, wherein said mobile terminal further comprises means for setting information, which is necessary in order for the server system to select a network for continuing communication in response to the service-start request, and registering this information with the server system.

8. The system according to claim 7, wherein said server system has means for displaying a menu image, which is for implementing said registration, at the mobile terminal.

9. The system according to claim 3, wherein said server system has means for accepting a request for changing the operating state of a service to a state such as “change”, “sleep”, “cancel” and “start”.

10. The system according to claim 3, wherein said server system has means for accepting, maintaining and managing information registered by the user and a request such as a change of registered content.

11. The system according to claim 6, wherein said server system has means for accepting, recording and comparing radio conditions of a plurality of networks reported by the mobile terminal.

12. The system according to claim 3, wherein said server system has address management means for executing call setup processing in a different network;
said address management means correlating addresses and telephone numbers etc. between different networks and continuing communication in different networks based upon the correlation.

13. The system according to claim 3, wherein said server system has means for mediating settlement of accounts necessary with regard to a communications carrier in utilization of a service.

14. The system according to claim 3, wherein said server system includes:
means for acquiring temporary communication permission and a provisional telephone number from the network for continuing communication if there is no communication contract between this network and the mobile terminal; and
means for allowing communication between the mobile terminal and a communicating party to continue using the provisional telephone number.

15. A mobile terminal in a communication system having the mobile terminal for communicating with a terminal of another party by utilizing a prescribed network from among a plurality of networks, and a server system connected to each of the networks for exercising control whereby the mobile terminal is allowed to communicate with the other party via the prescribed network, said mobile terminal comprising:
means for detecting another network or deterioration of reception conditions during communication with the other party utilizing a first network;
means for transmitting a service-start request to the server system when another network is detected or when deterioration of reception conditions is detected;
display means for displaying networks presented by the server system in response to the service-start request;
means for selecting a network presented by the server system; and
means for notifying the server system of the selected network;
wherein the server system continues communication via the network of which it has been notified by the mobile terminal.

16. A mobile terminal in a communication system having the mobile terminal for communicating with a terminal of another party by utilizing a prescribed network from among a plurality of networks, and a server system connected to each of the networks for exercising control whereby the mobile terminal is allowed to communicate with the other party via the prescribed network, said mobile terminal comprising:
means for detecting another network or deterioration of reception conditions during communication with the other party utilizing a first network; and
means for transmitting a service-start request to the server system when another network is detected or when deterioration of reception conditions is detected;
wherein the server system selects a network for continuing communication in response to the service-start request and continues communication via this network.

17. The mobile terminal according to claim 15, further comprising a communication unit for communicating in each radio scheme of the plurality of networks.

18. The mobile terminal according to claim 17, further comprising:
a detector for detecting radio conditions of each of the networks; and
means for notifying the server system of these radio conditions;
said server system comparing the radio conditions of each of the networks and selecting a network for continuing communication.

19. The mobile terminal according to claim 15, further comprising means for setting information, which is necessary in order for the server system to select a network for continuing communication in response to the service-start request, and registering this information with the server system.
